(19) United States
(12) Patent Application Publication
(10) Pub. No.: US 2026/0044442 A1
(43) Pub. Date: Feb. 12, 2026

(54) MEMORY DEVICE COMPRESSING SOFT DECISION DATA, OPERATING METHOD THEREOF AND MEMORY SYSTEM

(71) Applicant: SAMSUNG ELECTRONICS CO., LTD., Suwon-si (KR)

(72) Inventors: Seoyeon CHOI, Suwon-si (KR); Jin-Young KIM, Suwon-si (KR); Se Hwan PARK, Suwon-si (KR); Eunhyang PARK, Suwon-si (KR)

(73) Assignee: SAMSUNG ELECTRONICS CO., LTD., Suwon-si (KR)

(21) Appl. No.: 19/196,372

(22) Filed: May 1, 2025

(30) Foreign Application Priority Data
Aug. 9, 2024 (KR) 10-2024-0106908

(51) Int. Cl. G06F 12/02

(52) U.S. Cl. CPC G06F 12/0223

(57) ABSTRACT

Provided is a memory device including a memory cell array, a page buffer circuit that acquires soft decision (SD) data including a plurality of SD data segments from a plurality of memory units in memory cell array using a soft read voltage, and a compression circuit that compresses the SD data into compressed data including a plurality of compressed data segments corresponding to the plurality of SD data segments, in which the compression circuit compresses the plurality of SD data segments based on a fixed compression ratio determined based on information associated with an error bit to be corrected using the SD data and a plurality of variable compression ratios respectively applied to the plurality of SD data segments.

### CROSS-REFERENCE TO RELATED APPLICATION

This application is based on and claims priority to Korean Patent Application No. 10-2024-0106908, filed in the Korean Intellectual Property Office on Aug. 9, 2024, the entire contents of which are hereby incorporated by reference.

### BACKGROUND

### 1. Field

The disclosure relates to a memory device, and more particularly, to a memory device for compressing soft decision (SD) data, an operating method of the memory device, and a memory system including the memory device.

### 2. Description of Related Art

Non-volatile memory device may read hard decision data (hereinafter, “HD data”) based on a hard read voltage, and generate soft decision data (hereinafter, “SD data”) by using read values that are read based on a plurality of soft read voltages.

In the process of transmitting the SD data to a memory controller to perform error correction, there is a problem in that some of the SD data is lost or overhead occurs.

### SUMMARY

Embodiments of the disclosure provide a memory device that compresses SD data using a fixed compression ratio and a variable compression ratio, an operating method of the memory device, and a memory system.

According to an aspect of the disclosure, there is provided a memory device, including: a memory cell array including a plurality of memory units; a page buffer circuit configured to acquire, using a soft read voltage, soft decision (SD) data including a plurality of SD data segments from the plurality of memory units; and compression circuit configured to compress the SD data into compressed data including a plurality of compressed data segments corresponding to the plurality of SD data segments, wherein the plurality of compressed data segments of the compressed data are generated by compressing the plurality of SD data segments according to a fixed compression ratio and a plurality of variable compression ratios, wherein the fixed compression ratio is determined based on information associated with an error bit to be corrected using the SD data, and wherein the plurality of variable compression ratios is respectively applied to the plurality of SD data segments.

According to an aspect of the disclosure, there is provided an operating method of a memory device, including: acquiring soft decision (SD) data including a plurality of SD data segments from a plurality of memory units in a memory cell array using a soft read voltage; determining a fixed compression ratio and a plurality of variable compression ratios applied to each of the plurality of SD data segments based on information associated with an error bit to be corrected using the SD data; and generating compressed data including a plurality of compressed data segments corresponding to the plurality of SD data segments based on the fixed compression ratio and the plurality of variable compression ratios.

According to an aspect of the disclosure, there is provided a memory system, including: a memory device configured to: acquire hard decision (DD) data from a memory cell array including a plurality of memory units using a hard read voltage, acquire soft decision (SD) data including a plurality of SD data segments from the plurality of memory units using a soft read voltage, determine a fixed compression ratio and a plurality of variable compression ratios applied to each of the plurality of SD data segments based on information associated with an error bit to be corrected using the SD data, and generate compressed data including a plurality of compressed data segments corresponding to the plurality of SD data segments based on the fixed compression ratio and the plurality of variable compression ratios; and a memory controller configured to: receive the HD data and the compressed data, decompress the compressed data to acquire the SD data, and correct an error in the HD data based on the HD data and the SD data.

According to various aspects of the disclosure, by determining a lower fixed compression ratio as the number of error bits to be corrected using the SD data decreases (or is expected to decrease), the size of compressed data generated from the SD data can be reduced.

According to various aspects of the disclosure, by determining a higher fixed compression ratio as the number of error bits to be corrected using the SD data increases (or is expected to increase), the loss of information during compression of the SD data can be prevented.

According to various aspects of the disclosure, by giving a high variable compression ratio to the SD data segment acquired from the corresponding memory unit as the number of error bits generated at positions corresponding to a specific memory unit on HD data increases, the problem of information loss during the SD data compression can be prevented.

According to various aspects of the disclosure, by giving a low variable compression ratio to the SD data segment corresponding to that memory unit as the number of error bits occurring at positions corresponding to a specific memory unit on HD data decreases, the problem of unnecessarily increasing the capacity of the compressed data due to insertion of dummy data, etc. can be prevented.

According to various aspects of the disclosure, by giving a higher variable compression ratio to the SD data segment corresponding to the corresponding memory unit as the number of error bits generated at positions corresponding to a specific memory unit on HD data increases, the problem of missing some information due to capacity limitations of the compressed data segment can be prevented.

According to various aspects of the disclosure, based on the reduction in the compression time of the SD data segment, overhead may decrease or may not occur during the SD data read.

Various advantages and effects of the disclosure are not limited to the above description, and may be more easily understood in the process of describing specific aspects of the disclosure.

### BRIEF DESCRIPTION OF DRAWINGS

The above and other objects, features and advantages of the present disclosure will become more apparent to those of ordinary skill in the art by describing in detail example embodiments thereof with reference to the accompanying drawings, in which:

FIG. 1 is a block diagram of a memory system according to an embodiment;

FIG. 2A is an example block diagram of a non-volatile memory device according to an embodiment;

FIG. 2B is an example block diagram illustrating a memory cell array of FIG. 2A in detail;

FIG. 3 is a diagram illustrating ideal threshold voltage distributions of a triple level cell (TLC) according to an embodiment;

FIG. 4 is a diagram illustrating deteriorating threshold voltage distributions of the TLC;

FIG. 5 is a diagram for illustrating an SD read operation according to an embodiment;

FIG. 6 is a block diagram of a memory system according to an embodiment;

FIG. 7 is a diagram for illustrating a read operation of the non-volatile memory device according to an embodiment;

FIG. 8 is a diagram for illustrating an operating method of a compression circuit according to an embodiment;

FIGS. 9A and 9B are diagrams for illustrating a method of compressing an SD data sub-segment according to an embodiment;

FIG. 10 is a diagram for illustrating a position mapping table according to an embodiment;

FIGS. 11A to 11C are diagrams for illustrating a method of compressing an SD data sub-segment according to an embodiment;

FIG. 12 is a flowchart for illustrating an operating method of the memory device according to an embodiment;

FIG. 13 is a flowchart for illustrating an operating method of the memory controller according to an embodiment;

FIG. 14 is a flowchart for illustrating an operation S1240 of FIG. 12 in detail;

FIGS. 15A and 15B are diagrams illustrating a defense code flow of the memory system to describe an operation S1242 of FIG. 14;

FIGS. 16A and 16B are diagrams illustrating an error profile of the memory device to explain an operation S1242 of FIG. 14;

FIG. 17A is a flowchart for illustrating an operation S1244 of FIG. 14 in detail;

FIG. 17B is a diagram illustrating an example in which a variable compression ratio is determined according to the number of error bits per memory unit according to an embodiment;

FIG. 18 is a diagram illustrating an example of compressed data according to an embodiment;

FIG. 19 is a diagram illustrating an example of compressed data sub-segments according to an embodiment; and FIGS. 20A and 20B are diagrams illustrating an example in which an overhead is reduced in the SD data read operation according to an embodiment.

### DETAILED DESCRIPTION

Hereinafter, various embodiments of the disclosure will be described with reference to the accompanying drawings.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

The embodiments of the disclosure are example embodiments, and thus, the disclosure is not limited thereto, and may be realized in various other forms. As is traditional in the field, embodiments may be described and illustrated in terms of blocks, as shown in the drawings, which carry out a described function or functions. These blocks, which may be referred to herein as units or modules or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

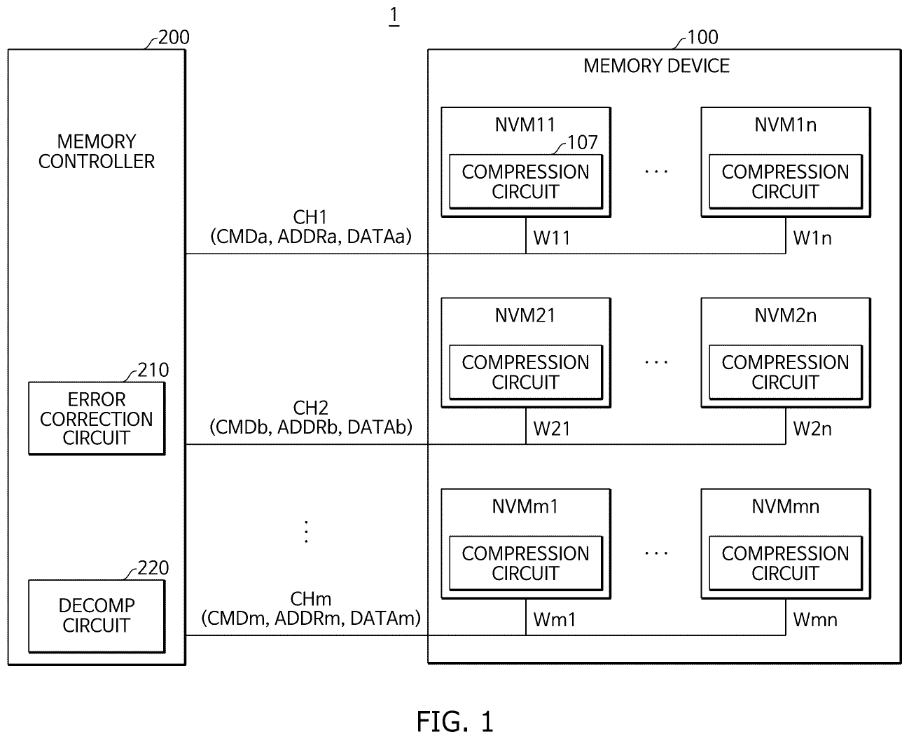

FIG. 1 is a block diagram of a memory system 1 according to an embodiment.

Referring to FIG. 1, the memory system 1 may include a memory device 100 and a memory controller 200. The memory system 1 may support a plurality of channels CH1 to CHm, and the memory device 100 and the memory controller 200 may be connected to each other through the plurality of channels CH1 to CHm. For example, the memory system 1 may be implemented as a storage device. The storage device may include, but is not limited to, a solid state drive (SSD).

The memory device 100 may include a plurality of non-volatile memory devices NVM11 to NVMmn. Here, m and n are integers. Each of the non-volatile memory devices NVM11 to NVMmn may be connected to one of the plurality of channels CH1 to CHm through a corresponding line. For example, the non-volatile memory devices NVM11 to NVM1n may be connected to a first channel CH1 through lines W11 to W1n, and the non-volatile memory devices NVM21 to NVM2n may be connected to a second channel CH2 through lines W21 to W2n. Each of the non-volatile memory devices NVM11 to NVMmn may be implemented in any unit operable according to individual commands from the memory controller 200. For example, each of the non-volatile memory devices NVM11 to NVMmn may be implemented as a chip or die, but the disclosure is not limited thereto.

The memory controller 200 may transmit signals the memory device 100 through the plurality of channels CH1 to CHm and receive signals from the memory device 100 through the plurality of channels CH1 to CHm. For example, the memory controller 200 may transmit commands CMDa to CMDm, addresses ADDRa to ADDRm, and data DATAa to DATAm to the memory device 100 through the channels CH1 to CHm or receive the data DATAa to DATAm from the memory device 100.

The memory controller 200 may select, through each channel, one of the non-volatile memory devices connected to the respective channel and transmit signals to the selected non-volatile memory device and receive signals from selected non-volatile memory device. For example, the memory controller 200 may select a non-volatile memory device NVM11 from among the non-volatile memory devices NVM11 to NVM1n connected to the first channel CH1. The memory controller 200 may transmit the command CMDa, the address ADDRa, and the data DATAa to the selected non-volatile memory device NVM11 through the first channel CH1 or receive the data DATAa from the selected non-volatile memory device NVM11.

The memory controller 200 may transmit signals to the memory device 100 and receive signals from the memory device 100 in parallel through different channels. For example, the memory controller 200 may transmit the command CMDb to the memory device 100 through the second channel CH2, while transmitting the command CMDa to the memory device 100 through the first channel CH1. For example, the memory controller 200 may receive the data DATAb from the memory device 100 through the second channel CH2 while receiving the data DATAa from the memory device 100 through the first channel CH1.

The memory controller 200 may control the overall operation of the memory device 100. The memory controller 200 may transmit signals to the channels CH1 to CHm to control each of the non-volatile memory devices NVM11 to NVMmn connected to the channels CH1 to CHm. For example, the memory controller 200 may transmit the command CMDa and the address ADDRa to the first channel CH1 to control one of the non-volatile memory devices NVM11 to NVM1n.

Each of the non-volatile memory devices NVM11 to NVMmn may operate under the control of the memory controller 200. For example, the non-volatile memory device NVM11 may program the data DATAa according to the command CMDa, the address ADDRa, and the data DATAa provided through the first channel CH1. For example, the non-volatile memory device NVM21 may read the data DATAb according to the command CMDb and the address ADDRb provided through the second channel CH2, and transmit the read data DATAb to the memory controller 200.

Although FIG. 1 illustrates that the memory device 100 is in communication with the memory controller 200 through m channels and the memory device 100 includes n number of non-volatile memory devices corresponding to each of the channels, the number of channels and the number of non-volatile memory devices connected to one channel may be variously changed.

According to an embodiment, the error correction circuit 210 may include an error correction circuit 210 and decompression circuit 220. The error correction circuit 210 may be configured to correct an error in the data read from the memory device 100. The error correction circuit 210 may be provided inside the memory controller 200. According to an embodiment, the error correction circuit 210 may be configured to perform a hard decision (HD) method (hereinafter, “HD method”) and a soft decision (SD) method (hereinafter, “SD method”) as the error correction method.

The HD method may be a technique of correcting errors in data by using read data (hereinafter referred to as “hard decision data” or “HD data”) and error correction codes according to the on/off characteristics of memory cells when a reference voltage (hereinafter, “hard read voltage”) is applied. The reference voltage may be a predetermined reference voltage.

The SD method may be a technique of correcting errors in data by further using additional information on the reliability of HD data (hereinafter, “soft decision data” or “SD data”). For example, in addition to using the HD data and error correction codes, the SD method further use additional information on the reliability of HD data (hereinafter, “soft decision data” or “SD data”).

The memory controller 200 may provide a read command for HD data and/or SD data to the memory device 100. The memory device 100 may provide HD data acquired from the non-volatile memory device selected from among the non-volatile memory devices NVM11 to NVMmn to the memory controller 200. The memory device 100 may compress the SD data acquired from the selected non-volatile memory device, and provide the compressed data generated by compressing the SD data to the memory controller 200.

The decompression circuit 220 may decompress the compressed data to generate SD data, and provide the SD data to the error correction circuit 210. The error correction circuit 210 may correct an error of the HD data based on the HD data and the SD data. For example, the error correction circuit 210 may correct the HD data by changing the log likelihood ratio (LLR) based on the SD data, but the disclosure is not limited thereto.

According to an embodiment, the SD data may represent an overlapping area of adjacent threshold voltage distributions as “1”, and other areas as “0”. The overlapping area of the threshold voltage distributions may be an area of HD data with a low reliability. The other areas may be areas of HD data with a relatively high reliability. Since the overlapping area of the adjacent threshold voltage distributions is narrower than the other areas, the number of ones (1) in the SD data may be less than the number of zeroes (0).

Accordingly, a compression circuit 107 included in each of the non-volatile memory devices NVM11 to NVMmn may encode “1” in the SD data to a position of “1” to generate compressed data.

The compression circuit 107 included in each of the non-volatile memory devices NVM11 to NVMmn may apply the same or different compression ratios to each SD data segment which is a part of SD data acquired from a specific memory unit in the memory cell array included in each of the non-volatile memory devices NVM11 to NVMmn to generate compressed data. The specific memory unit may include, but is not limited to, a plurality of pages, one page, or part of a page. According to an embodiment of the disclosure, the “memory unit”may also be referred to as a “sector”.

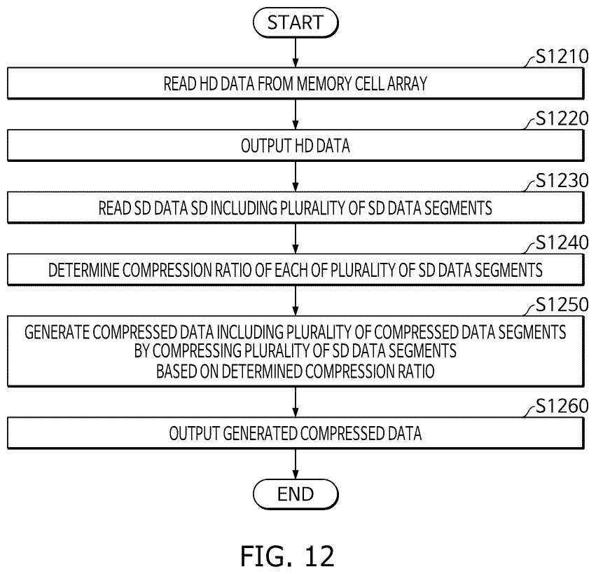

For example, a plurality of SD data segments acquired from a plurality of pages in the memory cell array included in one non-volatile memory device NVM11 may be compressed based on a fixed compression ratio and one or more variable compression ratios corresponding to a plurality of SD data segments. For example, the plurality of SD data segments may be compressed based on a fixed compression ratio and a plurality of variable compression ratios corresponding to a plurality of SD data segments as described in detail with reference to FIGS. 12 to 19.

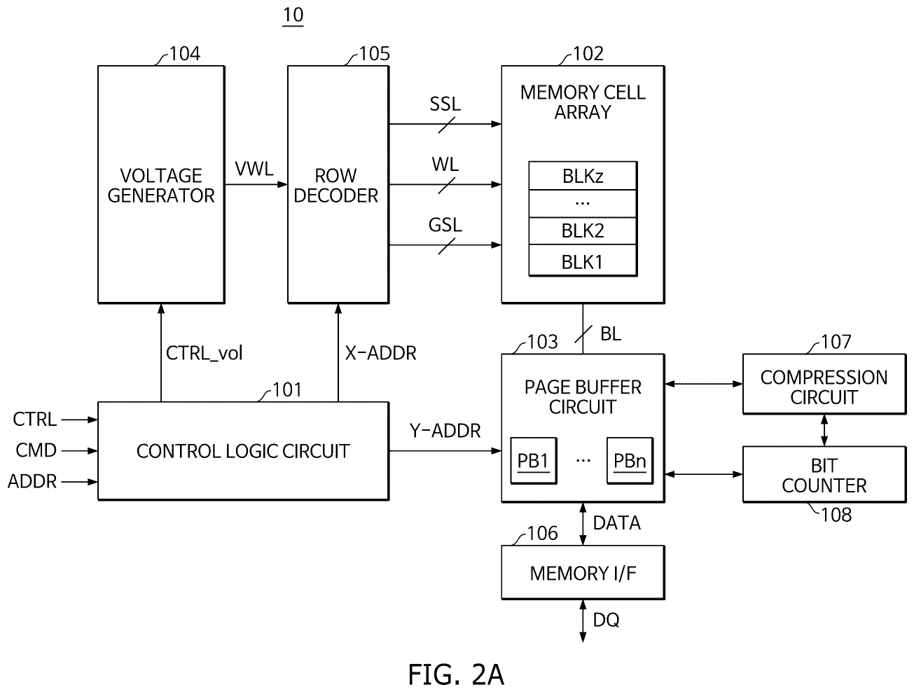

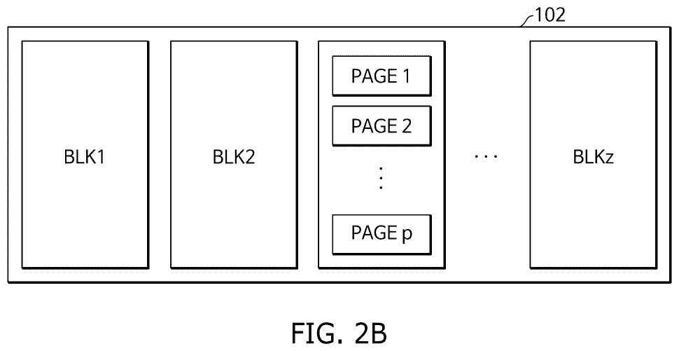

FIG. 2A is an example block diagram of a non-volatile memory device, and FIG. 2B is an example block diagram illustrating a memory cell array 102 of FIG. 2A in detail.

Referring to FIG. 2A, a non-volatile memory device 10 may include a control logic circuit 101, a memory cell array 102, a page buffer circuit 103, a voltage generator 104, a row decoder 105, a memory interface circuit 106, a compression circuit 107 and a bit counter 108. The non-volatile memory device 10 may correspond to at least one of the plurality of non-volatile memory devices NVM11 to NVMmn of FIG. 1. However, the disclosure is not limited thereto, and as such, according to another embodiment, the non-volatile memory device may include one or more other components.-In some embodiments, the non-volatile memory device 10 may further include, but is not limited to, a column logic, a pre-decoder, a temperature sensor, a command decoder, an address decoder, etc.

The control logic circuit 101 may overall control various operations of the non-volatile memory device 10. The control logic circuit 101 may output various control signals based on the command CMD and/or the address ADDR from the memory interface circuit 106. For example, the control logic circuit 101 may output various control signals in response to the command CMD and/or the address ADDR from the memory interface circuit 106. For example, the control logic circuit 101 may output a voltage control signal CTRL_vol, a row address X-ADDR, and a column address Y-ADDR.

The memory cell array 102 may include a plurality of memory blocks BLK1 to BLKz (where, z is a positive integer), and each of the plurality of memory blocks BLK1 to BLKz may include a plurality of memory cells.

Referring to FIG. 2B, each of the plurality of memory blocks BLK1 to BLKz may include a plurality of pages PAGE1 to PAGEp (where, p is a positive integer). Each of the plurality of pages PAGE1 to PAGEp may correspond to each of the word lines WL. Additionally, each of the plurality of pages PAGE1 to PAGEp may include a plurality of memory cells connected to a corresponding word line.

The non-volatile memory device 10 may perform an erase operation on each of the plurality of memory blocks BLK1 to BLKz, and may perform a programming operation or read operation on the plurality of pages PAGE1 to PAGEp. Data writing and reading may be performed in units of pages, and electrical erasing may be performed in units of blocks.

Referring back to FIG. 2A, the memory cell array 102 may be connected to the page buffer circuit 103 through bit lines BL, and may be connected to the row decoder 105 through word lines WL, string select lines SSL, and ground select lines GSL. The number of memory cell arrays included in the non-volatile memory device 10 is not limited to the above.

The memory cell array 102 may include a 3D memory cell array, and the three-dimensional memory cell array may include a plurality of NAND strings. Each NAND string may include memory cells each connected to word lines vertically stacked on a substrate. U.S. Pat. Nos. 7,679,133, 8,553,466, 8,654,587 and 8,559,235, and U.S. Patent Publication No. 2011/0233648 are hereby incorporated herein by reference in their entirety. The memory cell array 102 may include a two-dimensional memory cell array, and the 2D memory cell array may include a plurality of NAND strings provided along row and column directions.

The page buffer circuit 103 may include a plurality of page buffers PB1 to PBn (where, n is an integer of 2 or more), and the plurality of page buffers PB1 to PBn may be connected to the memory cells through a plurality of bit lines BL, respectively. The page buffer circuit 103 may select at least one bit line from among the bit lines BL based on the column address Y-ADDR. For example, the page buffer circuit 103 may select at least one bit line from among the bit lines BL in response to the column address Y-ADDR.

The page buffer circuit 103 may operate as a write driver or a sense amplifier according to an operation mode. For example, during a program operation, the page buffer circuit 103 may apply a bit line voltage corresponding to data to be programmed to the selected bit line. During a read operation, the page buffer circuit 103 may detect a current or voltage of the selected bit line to detect data stored in the memory cell.

The page buffer circuit 103 may obtain HD data or SD data from the memory cell array 102. The compression circuit 107 may compress the SD data of each unit size to generate compressed data. The compression circuit 107 may compress SD data segments of a unit size (e.g., 16 KB) to sequentially generate compressed data segments, and store the compressed data segments in the page buffer circuit 103. The SD data segments of the unit size may be data acquired for one page, a plurality of pages, or at least a portion of one page in the memory cell array 102.

In an example case in which compression of the SD data is completed by the compression circuit 107, the generated compressed data may be output to a DQ pin through the memory interface circuit 106. According to an embodiment, the DQ pin may also be referred to as an I/O pin.

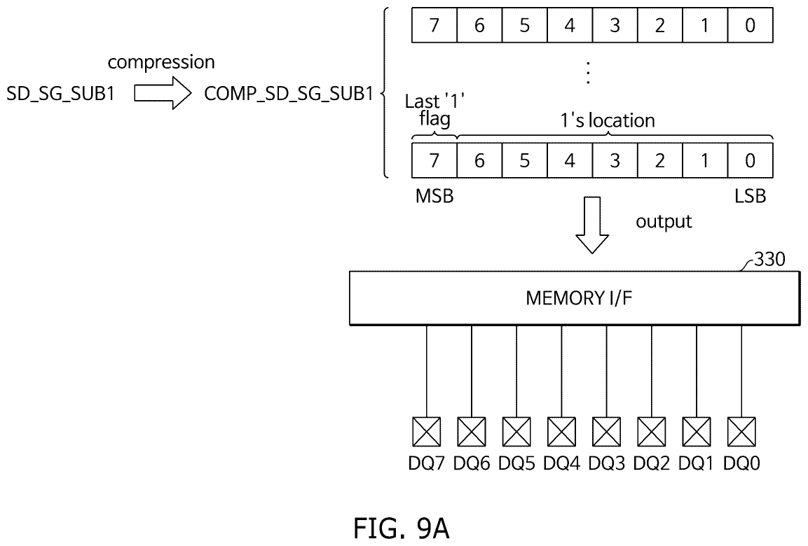

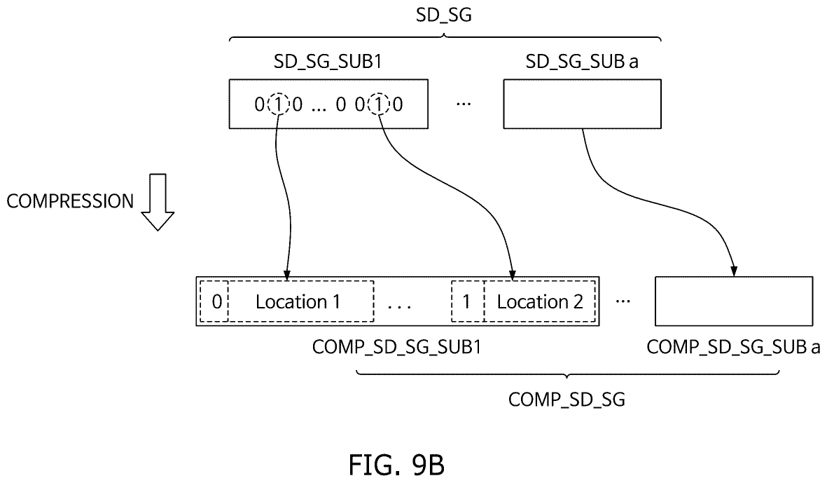

The compression circuit 107 may generate compressed data by encoding a position of a bit representing a minor value among bits included in the SD data. Details of the compression method may be described in detail below with reference to FIGS. 9A to 11. According to an embodiment, the minor value is described as “1”. However, the disclosure not limited thereto, and as such, the minor value may be described in another manner.

The minor value may correspond to the overlapping area of adjacent threshold voltage distributions, and a major value may correspond to the other areas. For example, the minor value (or bit) of the SD data may correspond to areas with relatively low read reliability in the threshold voltage distributions of a plurality of memory cells included in the memory cell array, and the major value (or bit) of SD data may correspond to areas with relatively high read reliability in the threshold voltage distributions.

The bit counter 108 may be connected to the page buffer circuit 103 to count the number of error bits for at least a portion of the HD data acquired from the memory cell array 102 by the page buffer circuit 103. The bit counter 108 may be a mass-bit counter (MBC) implemented in an analog or digital manner.

For example, the bit counter 108 may count the number of error bits occurred in a portion of the HD data for one memory unit (e.g., a plurality of pages, one page, or a portion of the page in the memory cell array 102). The bit counter 108 may repeat this process until the number of error bits is counted for the entire HD data.

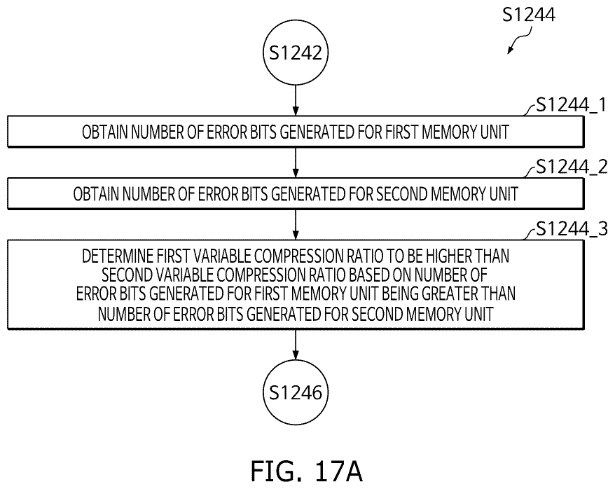

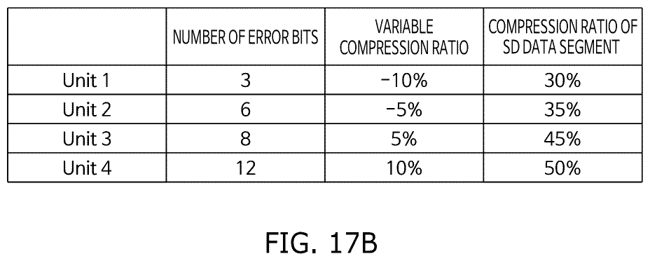

The number of error bits counted by the bit counter 108 may be transmitted to the compression circuit 107. The number of error bits may be directly transmitted to the compression circuit 107 or transmitted through the page buffer circuit 103. The compression circuit 107 may determine a compression ratio for a plurality of SD data segments included in the SD data based on information associated with the received number of error bits. For example, the compression ratio of the first SD data segment acquired from the first memory unit and the compression ratio of the second SD data segment acquired from the second memory unit may be different from each other. This will be described in detail below with reference to FIGS. 17A to 19.

The voltage generator 104 may generate various types of voltages to perform program, read, and erase operations based on the voltage control signal CTRL_vol. For example, the voltage generator 104 may generate, as a word line voltage VWL, a program voltage, a read voltage, a program verification voltage, an erase voltage, etc.

The row decoder 105 may select one of a plurality of word lines WL based on the row address X-ADDR and may select one of a plurality of string select lines SSL. For example, the row decoder 105 may select one of a plurality of word lines WL in response to the row address X-ADDR and may select one of a plurality of string select lines SSL. For example, during the program operation, the row decoder 105 may apply the program voltage and the program verification voltage to the selected word line, and during the read operation, the row decoder 105 may apply the read voltage to the selected word line.

The memory interface circuit 106 may transmit and receive data through the DQ pin.

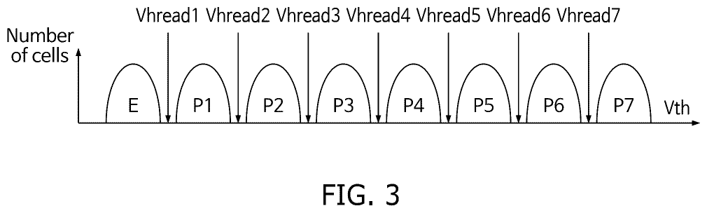

FIG. 3 is a diagram illustrating ideal threshold voltage distributions of a triple level cell (TLC).

Referring to FIGS. 2A and 3, in an example case in which the non-volatile memory device 10 is a triple level cell (TLC) memory device capable of storing three bits in one memory cell in the memory cell array 102, the threshold voltage of the memory cell may be programmed to one of eight threshold voltages in order to program three bits in one memory cell. Meanwhile, since the memory cells programmed to have the same threshold voltage have differences in electrical characteristics, the threshold voltages of a plurality of memory cells programmed to have the same threshold voltage may form the threshold voltage distributions as illustrated in FIG. 3. Accordingly, the TLC memory device may be configured to form eight threshold voltage distributions E and P1 to P7.

In an example case in which the threshold voltage distributions of the memory cell array 102 are in an ideal state as illustrated in FIG. 3, the read operation using the hard read voltages Vhread1 to Vhread7 illustrated in FIG. 3 may be performed, thus acquiring read data with fewer errors with the increased probability of successful error correction decoding. In this description, the read operation using the hard read voltages Vhread1 to Vhread7 may be referred to as an HD read operation. The HD read operation may also be referred to as a normal read operation. The HD read operation may refer to reading the data stored in the memory cell as 1 or 0 according to on or off state of the memory cell based on the hard read voltages Vhread1 to Vhread7 being supplied to the word line of the memory cell.

However, the threshold voltage distributions may be deteriorated as the operation of the memory cell array 102 is repeated.

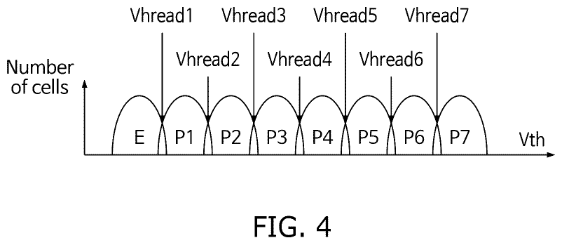

FIG. 4 is a diagram illustrating that the threshold voltage distributions of the TLC are deteriorated.

Referring to FIG. 4, the threshold voltage distributions may move to the left or right according to a charge loss that is generated as the electrons stored in the memory cell in the memory cell array 102 are released over time. Accordingly, the threshold voltage distributions of an erase state E and seven program states P1 to P7 may overlap each other.

In an example case in which the threshold voltage distributions overlap each other as described above, performing the read operation using the hard read voltages Vhread1 to Vhread7 may generate an Uncorrectable Error Correction Code (UECC) error due to many error bits.

For example, using the hard read voltage Vhread1 for reading requires that an on-cell in the erase state E on the left side and an off-cell in the program state P1 on the right side be distinguished. However the disclosure is not limited thereto, and as such, according to another embodiment, in an example case in which the cell distributions of the memory cell overlap each other as illustrated in FIG. 4, there may be memory cells that are actually the on-cells but read as the off-cells, and there may be memory cells that are actually the off-cells but read as the on-cells.

For example, with the threshold voltage distributions as illustrated in FIG. 4, performing the read operation using the hard read voltages Vhread1 to Vhread7 may result in the memory controller 200 receiving HD data with many errors (e.g., error bits, UECC bits), so there may be a high probability that error correction decoding will fail.

Therefore, the memory controller 200 may acquire the SD data through the SD read operation and perform the error correction decoding based on the SD data. The SD data may indicate the reliability of the HD data by distinguishing overlapping areas of the threshold voltage distributions and other areas.

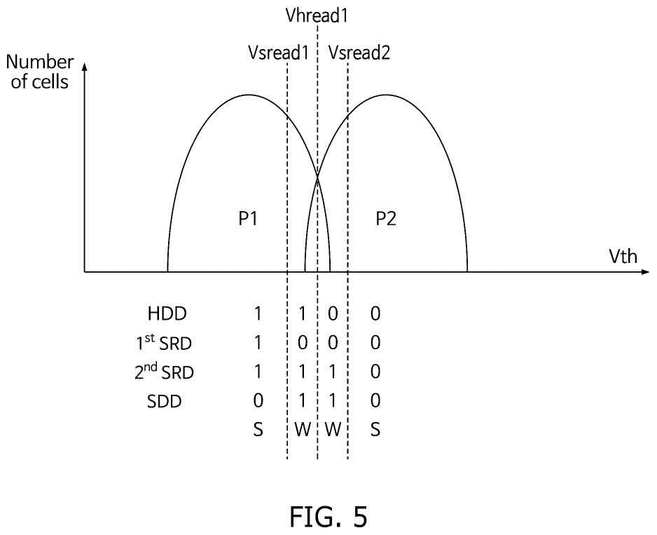

FIG. 5 is a diagram for illustrating an SD read operation.

As illustrated in FIG. 5, the soft read voltages used in the SD read operation may be Vsread1 and Vsread2. The SD read operation may refer to applying multiple soft read voltages Vsread1 and Vsread2 based on the hard read voltage Vhread1 to the memory cell. For example, voltages Vsread1 and Vsread2 may be a predetermined voltage difference from the hard read voltage Vhread1. The soft read voltages Vsread1 and Vsread2 may be applied to obtain information that adds reliability to the HD data HDD. In an example case in which the soft read voltage Vsread1 is applied to the memory cell, the data (1^{st} SRD) determined according to on or off of the memory cell may be 1, 0, 0, and 0. In an example case in which the soft read voltage Vsread2 is applied to the memory cell, the data (2^{nd} SRD) determined according to on or off of the memory cell may be 1, 1, 1, and 0.

An exclusive OR (XOR) operation may be performed on the read values (1^{st} SRD and 2^{nd} SRD) obtained by two read operations to form the SD data SDD. As illustrated in the drawing, the SD data SDD may be 0, 1, 1, and 0. The XOR operation may be performed in the page buffer circuit 103. For example the XOR operation may be performed on the read values (1^{st} SRD and 2^{nd} SRD) obtained by two read operations, using a plurality of latches in the page buffer circuit 103. The SD data SDD may indicate the reliability of the HD data HDD. The SD data SDD of 0 may indicate that the HD data is in a state of high reliability, that is, strong (S), and the SD data SDD of 1 may indicate that the HD data is in a state of low reliability, that is, weak (W). That is, 10, 11, 01, 00 that is a combination of the HD data HDD of 1, 1, 0, and 0 and the SD data SDD of 0, 1, 1, and 0 may mean high-reliability HD data HDD 1, low-reliability HD data HDD 1, low-reliability HD data HDD 0, and high-reliability HD data HDD 0, respectively.

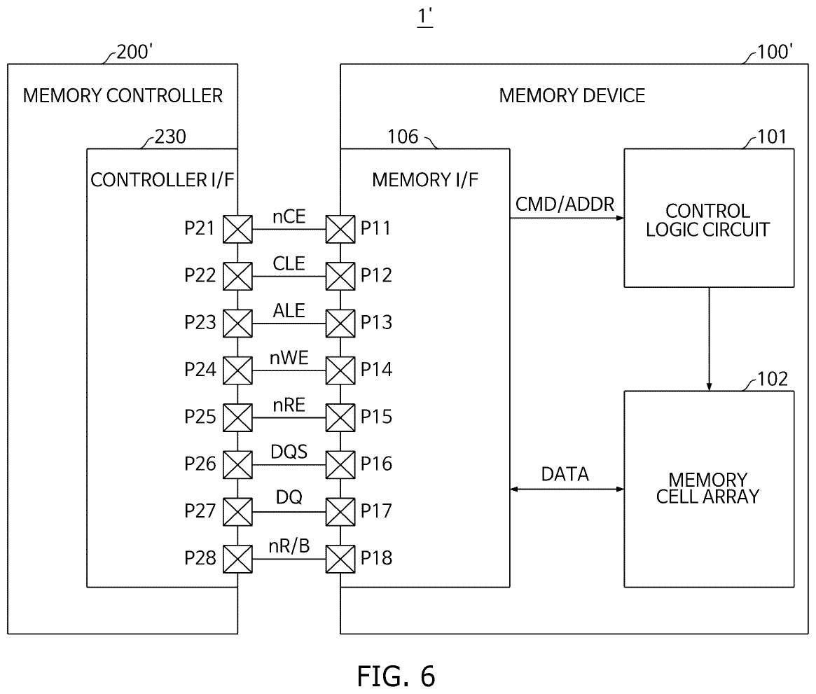

FIG. 6 is a block diagram of a memory system according to an embodiment.

Referring to FIG. 6, a memory system 1′ may include a memory device 100′ and a memory controller 200′. The memory device 100′ may correspond to one of the non-volatile memory devices NVM11 to NVMmn in communication with the memory controller 200′ based on one of the plurality of channels CH1 to CHm of FIG. 1, or to the non-volatile memory device 10 of FIG. 2. The memory controller 200′ may correspond to the memory controller 200 of FIG. 1.

The memory device 100′ may include first to eighth pins P11 to P18, the memory interface circuit 106, the control logic circuit 101, and the memory cell array 102.

The memory interface circuit 106 may receive a chip enable signal nCE from the memory controller 200′ through a first pin P11. According to the chip enable signal nCE, the memory interface circuit 106 may transmit signals to the memory controller 200′ through second to eighth pins P12 to P18 and receive signals from the memory controller 200′ through second to eighth pins P12 to P18. For example, in a case in which the chip enable signal nCE is in an enable state (e.g., a low level), the memory interface circuit 106 may transmit signals to the memory controller 200′ through the second to eighth pins P12 to P18 and receive signals from the memory controller 200′ through second to eighth pins P12 to P18.

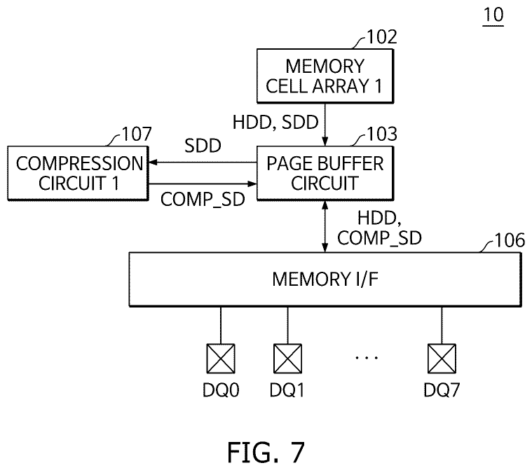

The memory interface circuit 106 may receive a command latch enable signal CLE from the memory controller 200′ through the second pin P12, an address latch enable signal ALE from the memory controller 200′ through the third pin P13, and a write enable signal nWE from the memory controller 200′ through the fourth pin P14. The memory interface circuit 106 may receive a data signal DQ from the memory controller 200′ or transmit the data signal DQ to the memory controller 200′ through the seventh pin P17. The command CMD, the address ADDR, and the data DATA may be transmitted through the data signal DQ. For example, the data signal DQ may be transmitted through a plurality of data signal lines. In this case, the seventh pin P17 may include a plurality of pins corresponding to a plurality of data signals. For example, as illustrated in FIG. 7, the memory device 100′ may provide the data DATA to the memory controller 200′ through eight DQ pins (DQ0 to DQ7 pins).

The memory interface circuit 106 may obtain the command CMD from the data signal DQ received in an enable period (e.g., a high level state) of the command latch enable signal CLE based on toggle timing of the write enable signal nWE. The memory interface circuit 106 may obtain the address ADDR from the data signal DQ received in an enable period (e.g., a high level state) of the address latch enable signal ALE based on toggle timing of the write enable signal nWE.

The write enable signal nWE may maintain a static state (e.g., a high level or a low level) and then toggle between the high level and the low level. For example, the write enable signal nWE may toggle in a period in which the command CMD and/or the address ADDR are transmitted. Accordingly, the memory interface circuit 106 may obtain the command CMD and/or the address ADDR based on the toggle timing of the write enable signal nWE.

The memory interface circuit 106 may receive a read enable signal nRE from the memory controller 200′ through the fifth pin P15. A memory interface circuit 106 may receive a data strobe signal DQS from the memory controller 200′ or transmit the data strobe signal DQS to the memory controller 200′ through the sixth pin P16.

In a data DATA output operation of the memory device 100′, before outputting the data DATA, the memory interface circuit 106 may receive the read enable signal nRE that toggles through the fifth pin P15. The memory interface circuit 106 may generate the data strobe signal DQS that toggles based on toggling of the read enable signal nRE. For example, the memory interface circuit 106 may generate the data strobe signal DQS that starts toggling after a predetermined delay (e.g., tDQSRE) based on a toggling start time of the read enable signal nRE. The memory interface circuit 106 may transmit the data signal DQ including the data DATA based on the toggle timing of the data strobe signal DQS. Accordingly, the data DATA may be aligned with the toggle timing of the data strobe signal DQS and transmitted to the memory controller 200′.

In a data DATA input operation of the memory device 100′, in an example case in which the data signal DQ including the data DATA is received from the memory controller 200′, the memory interface circuit 106 may receive the data strobe signal DQS that toggles with the data DATA from the memory controller 200′. The memory interface circuit 106 may obtain the data DATA from the data signal DQ based on the toggle timing of the data strobe signal DQS. For example, the memory interface circuit 106 may obtain the data DATA by sampling the data signal DQ at a rising edge and a falling edge of the data strobe signal DQS.

The memory interface circuit 106 may transmit a ready/busy output signal nR/B to the memory controller 200′ through the eighth pin P18. The memory interface circuit 106 may transmit state information of the memory device 100′ to the memory controller 200′ through the ready/busy output signal nR/B. In an example case in which the memory device 100′ is in the busy state (e.g., in an example case in which internal operations of the memory device 100′ are being performed), the memory interface circuit 106 may transmit the ready/busy output signal nR/B indicating a busy state to the memory controller 200'. In an example case in which the memory device 100′ is in the ready state (e.g., in an example case in which internal operations of the memory device 100′ are not performed or are complete), the memory interface circuit 106 may transmit the ready/busy output signal nR/B indicating the ready state to the memory controller 200′. For example, while the memory device 100′ is reading the data DATA from the memory cell array 102 based on a page read command, the memory interface circuit 106 may transmit the ready/busy output signal nR/B indicating the busy state (e.g., a low level) to the memory controller 200′. For example, while the memory device 100′ is programming the data DATA in the memory cell array 102 in response to a program command, the memory interface circuit 106 may transmit the ready/busy output signal nR/B indicating the busy state to the memory controller 200′.

The control logic circuit 101 may overall control various operations of the memory device 100′. The control logic circuit 101 may receive the command/address CMD/ADDR obtained from the memory interface circuit 106. The control logic circuit 101 may generate control signals for controlling other components of the memory device 100′ according to the received command/address CMD/ADDR. For example, the control logic circuit 101 may generate various control signals for programming the data DATA in the memory cell array 102 or for reading the data DATA from the memory cell array 102.

The memory cell array 102 may store the data DATA obtained from the memory interface circuit 106 under the control of the control logic circuit 101. The memory cell array 102 may output the stored data DATA to the memory interface circuit 106 under the control of the control logic circuit 101.

The memory cell array 102 may include a plurality of memory cells. For example, the plurality of memory cells may be flash memory cells. However, the disclosure is not limited to the above, and as such, according to another embodiment, the memory cells may include, but is not limited to, Resistive Random Access Memory (RRAM) cells, Ferroelectric Random Access Memory (FRAM) cells, Phase Change Random Access Memory (PRAM) cells, Thyristor Random Access Memory (TRAM) cells, and Magnetic Random Access Memory (MRAM) cells. Embodiments of the disclosure will be described below mainly with reference to the NAND flash memory cells as an example of the memory cells.

The memory controller 200′ may include first to eighth pins P21 to P28 and a controller interface circuit 230. The first to eighth pins P21 to P28 may correspond to the first to eighth pins P11 to P18 of the memory device 100′.

The controller interface circuit 230 may transmit the chip enable signal nCE to the memory device 100 through the first pin P21. The controller interface circuit 230 may transmit signals to the memory device 100′ selected through the chip enable signal (nCE), through the second to eighth pins P22 to P28, and receive signals from the memory controller 100′ through second to eighth pins P22 to P28.

The controller interface circuit 230 may transmit the command latch enable signal CLE, the address latch enable signal ALE, and the write enable signal nWE to the memory device 100′ through the second to fourth pins P22 to P24. The controller interface circuit 230 may transmit the data signal DQ to the memory device 100′ or receive the data signal DQ from the memory device 100′ through the seventh pin P27.

The controller interface circuit 230 may transmit the data signal DQ including the command CMD or the address ADDR together with the toggling write enable signal nWE to the memory device 100′. According to an embodiment, based on the command latch enable signal CLE in an enable state, the controller interface circuit 230 may transmit the data signal DQ including the command CMD to a memory device 100′, and based on the address latch enable signal ALE in an enable state, the controller interface circuit 230 may transmit the data signal DQ including the address ADDR to the memory device 100′. For example, in response to transmitting the command latch enable signal CLE with the enable state, the controller interface circuit 230 may transmit the data signal DQ including the command CMD to a memory device 100′, and in response to transmitting the address latch enable signal ALE with the enable state, the controller interface circuit 230 may transmit the data signal DQ including the address ADDR to the memory device 100′.

The controller interface circuit 230 may transmit the read enable signal nRE to the memory device 100′ through the fifth pin P25. The controller interface circuit 230 may receive the data strobe signal DQS from the memory device 100′ or transmit the data strobe signal DQS to the memory device 100′ through the sixth pin P26.

In a data DATA output operation of the memory device 100′, the controller interface circuit 230 may generate a toggling read enable signal nRE and transmit the read enable signal nRE to the memory device 100′. For example, the controller interface circuit 230 may generate a read enable signal nRE that changes from a fixed state (e.g., a high level or a low level) to a toggle state before the data DATA is output. Accordingly, the data strobe signal DQS that toggles based on the read enable signal nRE may be generated in the memory device 100′. The controller interface circuit 230 may receive the data signal DQ including the data DATA together with the toggling data strobe signal DQS from the memory device 100′. The controller interface circuit 230 may obtain the data DATA from the data signal DQ based on the toggle timing of the data strobe signal DQS.

In the data DATA input operation of the memory device 100′, the controller interface circuit 230 may generate the toggling data strobe signal DQS. For example, the controller interface circuit 230 may generate the data strobe signal DQS that changes from a fixed state (e.g., a high level or a low level) to a toggle state before transmitting the data DATA. The controller interface circuit 230 may transmit the data signal DQ including the data DATA to the memory device 100′ based on the toggle timing of the data strobe signal DQS.

The controller interface circuit 230 may receive the ready/busy output signal nR/B from the memory device 100′ through the eighth pin P28. The controller interface circuit 230 may determine the state information of the memory device 100′ based on the ready/busy output signal nR/B.

According to an embodiment, the memory device 100′ may include a plurality of memory cell arrays, and the memory interface circuit 106 may provide HD data and SD data obtained from the plurality of memory cell arrays to the memory controller 200′ through the seventh pin P17.

FIG. 7 is a diagram for illustrating a read operation of the non-volatile memory device 10.

The page buffer circuit 103 may obtain HD data HDD and SD data SDD from the memory cell array 102. The compression circuit 107 may compress the SD data SDD to generate compressed data COMP_SD. The page buffer circuit 103 may provide the HD data HDD and the compressed data COMP_SD to the memory interface circuit 106.

The memory interface circuit 106 may output the HD data HDD and the compressed data COMP_SD through the first to eighth DQ pins DQ0 to DQ7 (corresponding to the seventh pin P17 of FIG. 6).

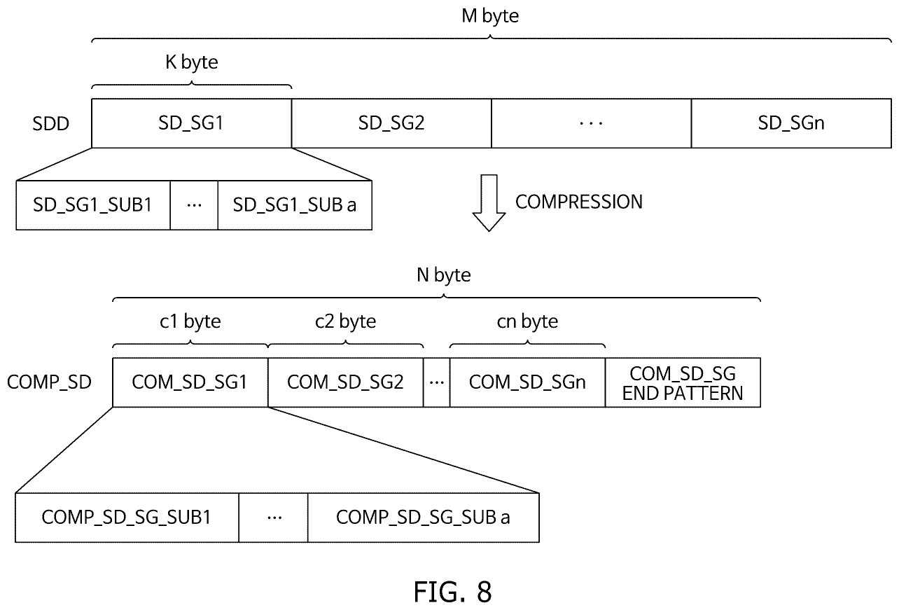

FIG. 8 is a diagram for illustrating an operating method of a compression circuit.

Referring to FIGS. 1, 2A and 8, the size of the SD data SDD may be M bytes, and may be divided into a plurality of SD data segments SD_SG1 to SD_SGn. M may be 16K. However, the disclosure is not limited thereto, and as such according to another embodiment, M may be an integer different than 16K. Each of the plurality of SD data segments SD_SG1 to SD_SGn may have a size of K bytes smaller than M bytes. For example, K may be a multiple of 16. However, the disclosure is not limited thereto, and as such according to another embodiment, K may be different than a multiple of 16. Each of the plurality of SD data segments SD_SG1 to SD_SGn may be data obtained for each memory unit (e.g., a plurality of pages, one page, or a portion of one page).

Each of the plurality of SD data segments SD_SG1 to SD_SGn may be divided into a plurality of SD data sub-segments SD_SG_SUB1 to SD_SG_SUBa. The size of each of the plurality of SD data sub-segments SD_SG_SUB1 to SD_SG_SUBa may be L bytes which is smaller than K bytes. For example, L may be 16.

Each of the plurality of SD data segments SD_SG1 to SD_SGn may be data obtained for a plurality of pages, and each of the plurality of SD data sub-segments SD_SG_SUB1 to SD_SG_SUBa may be data obtained for one page.

According to another embodiment, each of the plurality of SD data segments SD_SG1 to SD_SGn may be data obtained for one page, and each of the plurality of SD data sub-segments SD_SG_SUB1 to SD_SG_SUBa may be data obtained for a portion of one page.

The size of the compressed data COM_SD may be N bytes smaller than M bytes, and may be divided into a plurality of compressed data segments COM_SD_SG1 to COM_SD_SGn. N may vary according to the degree of compression. In addition, N may vary according to the number of bits indicating the minor value (e.g., “1”) in the SD data SDD.

The sizes of the plurality of compressed data segments COM_SD_SG1 to COM_SD_SGn may be c1 to cn bytes, where c1 to cn may be the same or different from each other. Each of the plurality of compressed data segments COM_SD_SG1 to COM_SD_SGn may be divided into a plurality of compressed data sub-segments COM_SD_SG_SUB1 to COM_SD_SG_SUBa. The plurality of SD data sub-segments SD_SG_SUB1 to SD_SG_SUBa may be compressed into the plurality of compressed data sub-segments COM_SD_SG_SUB1 to COM_SD_SG_SUBa, respectively. The sizes of the plurality of compressed data sub-segments COM_SD_SG_SUB1 to COM_SD_SG_SUBa may be different depending on the compression ratio.

The compression circuit 107 may compress the plurality of SD data segments SD_SG1 to SD_SGn to generate the plurality of compressed data segments COM_SD_SG1 to COM_SD_SGn. For example, the compression circuit 107 may read one of the plurality of SD data segments SD_SG1 to SD_SGn, and encode a position of a bit representing the minor value in the plurality of SD data sub-segments SD_SG_SUB1 to SD_SG_SUBa included in the read SD data segment to generate the plurality of compressed data sub-segments COM_SD_SG_SUB1 to COM_SD_SG_SUBa.

According to an embodiment, after generating the last compressed data segment COM_SD_SGn, the compression circuit 107 may generate an end pattern COM_SD END PATTERN indicating the end of the compressed data. The end pattern COM_SD END PATTERN may be added to a rear end of the last compressed data segment COM_SD_SGn. According to another embodiment, the compression circuit 107 may add a total size value of the compressed data COMP_SD to the front end of the compressed data COM_SD after the last compressed data segment is generated.

FIGS. 9A and 9B are diagrams for illustrating a method of compressing the SD data sub-segment.

Referring to FIGS. 2A and 9A, the compression circuit 107 may encode each of the minor values (e.g., “1”) included in the SD data sub-segment SD_SG_SUB1 into eight bits respectively to generate the compressed data sub-segment COM_SD_SG_SUB1. For example, “1” included in the SD data sub-segment SD_SG_SUB1 may be encoded as seven bits indicating the position of the corresponding bit and one flag bit indicating whether the “1” is the last “1” in the SD data sub-segment SD_SG_SUB1. For example, an MSB bit corresponding to the eighth DQ pin DQ7 may indicate whether the encoded “1” as the last “1” flag is the last “1” in the SD data sub-segment SD_SG_SUB1, and the bits corresponding to the first to seventh DQ pins DQ0 to DQ6 may indicate the position of “1” in the SD data sub-segment SD_SG_SUB1. In an example case in which the last “1” in the SD data sub-segment SD_SG_SUB1 is encoded, the MSB bit of eight bits corresponding to the SD data sub-segment SD_SG_SUB1 may be “1”.

In an example case in which “1” other than the last one in the SD data sub-segment SD_SG_SUB1 is encoded, the MSB bit of the eight bits corresponding to the SD data sub-segment SD_SG_SUB1 may be “0”. However, the disclosure is not limited to the above, and as such, according an example case in which the last “1” in the SD data sub-segment SD_SG_SUB1 is encoded, the MSB bit of the eight bits corresponding the SD data sub-segment SD_SG_SUB1 may be “0”. In an example case in which “1” other than the last one in the SD data sub-segment SD_SG_SUB1 is encoded, the MSB bit of eight bits corresponding thereto may be “1”. Since the position of “1” is encoded using 7 bits, the size of the encodable SD data sub-segment SD_SG_SUB1 may be be 2⁷, i.e. 128 bits. Referring to FIG. 9A, since the number of DQ pins of the memory interface circuit 106 is 8, it has been described that 8 bits are used for encoding “1”, but the disclosure is not limited thereto. The “1” of the SD data sub-segment SD_SG_SUB1 may be encoded using a bit corresponding to an integer multiple of the number of DQ pins. Although it has been described that the MSB bit of eight bits is used to indicate the position of “1”, the disclosure is not limited thereto.

A ratio of the number of bits indicating “1” to the bits included in the SD data may be very small. For example, the number of bits indicating “1” among the bits included in the SD data may be about 2%. Therefore, even in an example case in which one bit is encoded as eight bits, the size of the SD data SDD may be greater than the size of the compressed data COMP_SD.

Referring to FIGS. 2A and 9B, the SD data segment SD_SG may be compressed into the compressed data segment COM_SD_SG. For example, the SD data sub-segments SD_SG_SUB1 to SD_SG_SUBa may be compressed into the compressed data sub-segments COM_SD_SG_SUB1 to COM_SD_SG_SUBa, respectively. The first “1” and the last “1” in the SD data sub-segment SD_SG_SUB1 may be encoded as eight bits, respectively. According to the encoding rule of FIG. 9A, among eight bits corresponding to the first “1”, the MSB bit may be “0”, and the remaining bits may indicate a first position. The MSB bit of eight bits corresponding to the last “1” may be “1”, and the remaining bits may indicate a second position. The description of the SD data sub-segment SD_SG_SUB1 may also be applicable to the other SD data sub-segments SD_SG_SUB2 to SD_SG_SUBa.

The memory controller 200 may decode the compressed data COMP_SD_SG in units of eight bits during decoding to determine the position of “1” in the SD data SDD. In an example case in which the MSB bit of the eight bits is 1, this is the last “1” in the SD data segment SD_SG, and accordingly, decoding the 128-bit SD data sub-segment SD_SG_SUB may be completed by including “0” in the positions other than the identified position of “1”, resulting in a 128-bit SD data sub-segment.

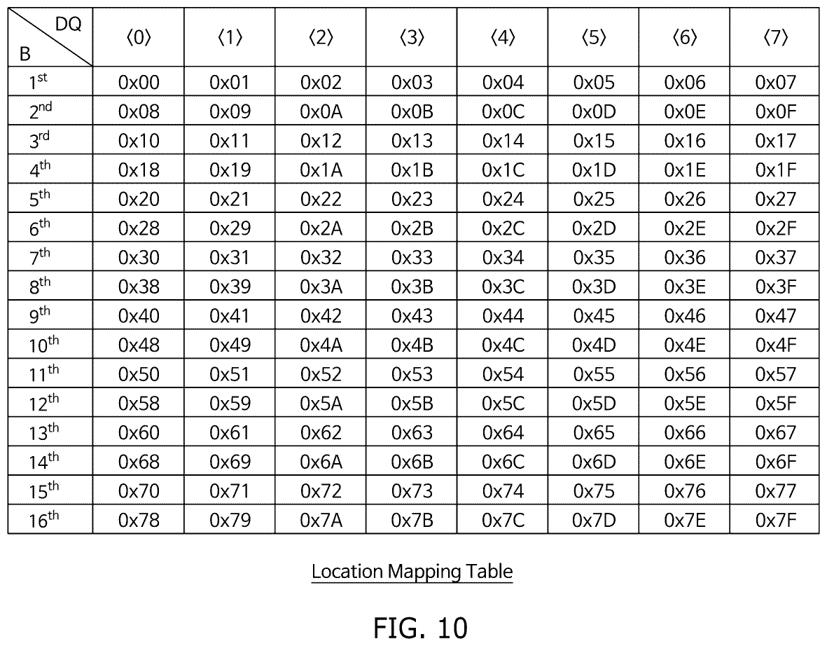

FIG. 10 is a diagram for illustrating a position mapping table. Referring to FIGS. 2A and 10, the compression circuit 107 may compress the SD data sub-segment SD_SG_SUB into the compressed data sub-segment COM_SD_SG_SUB with reference to the position mapping table. Specifically, the compression circuit 107 may encode “1” in the SD data sub-segment SD_SG_SUB with reference to the position mapping table.

The length of the SD data sub-segment SD_SG_SUB may be 128 bits. Eight bits output in parallel to the first to eighth DQ pins DQ0 to DQ7 may form one byte.

Referring to FIG. 10, since the position of the last bit included in the SD data sub-segment SD_SG_SUB is encoded as 0x7F, that is, 0111 1111, the 128 bits of positions may be encoded using 7 bits as an index. For example, as described above with reference to FIG. 9A, with reference to the position mapping table, the compression circuit 107 may represent the position of “1” included in the 128-bit SD data sub-segment SD_SG_SUB with seven bits.

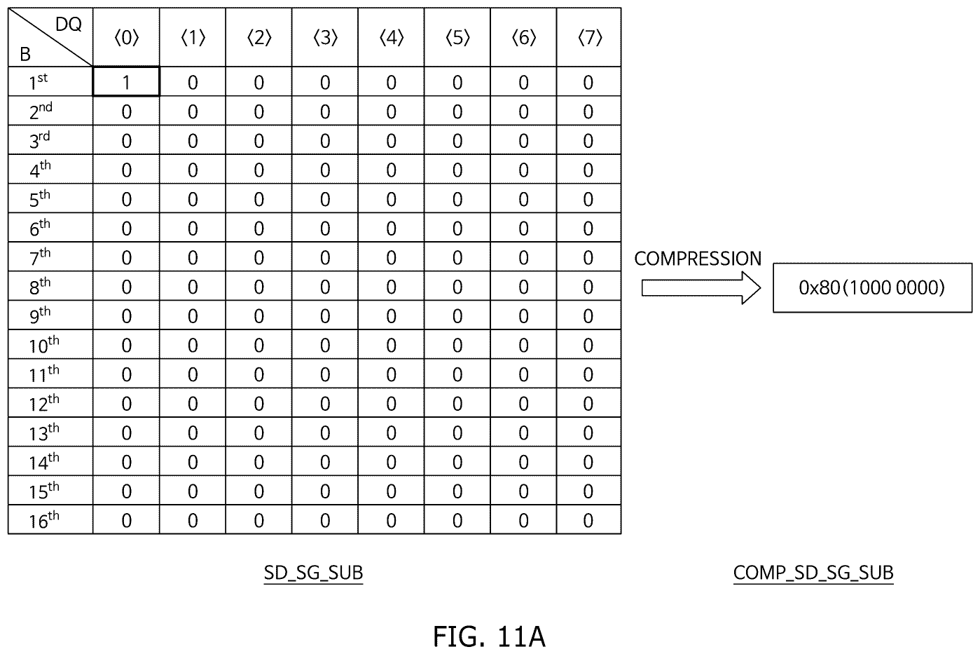

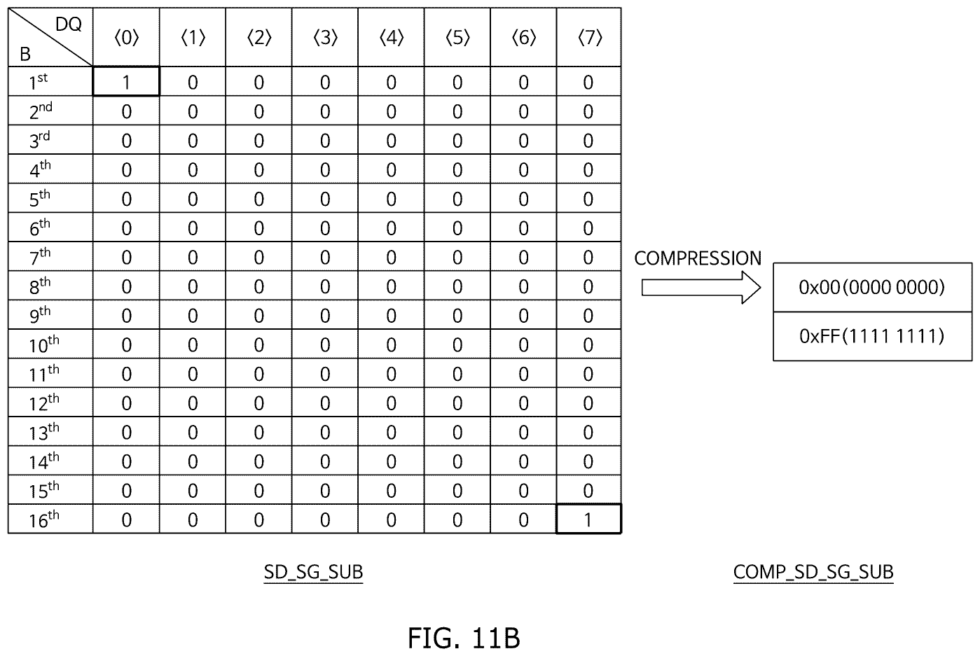

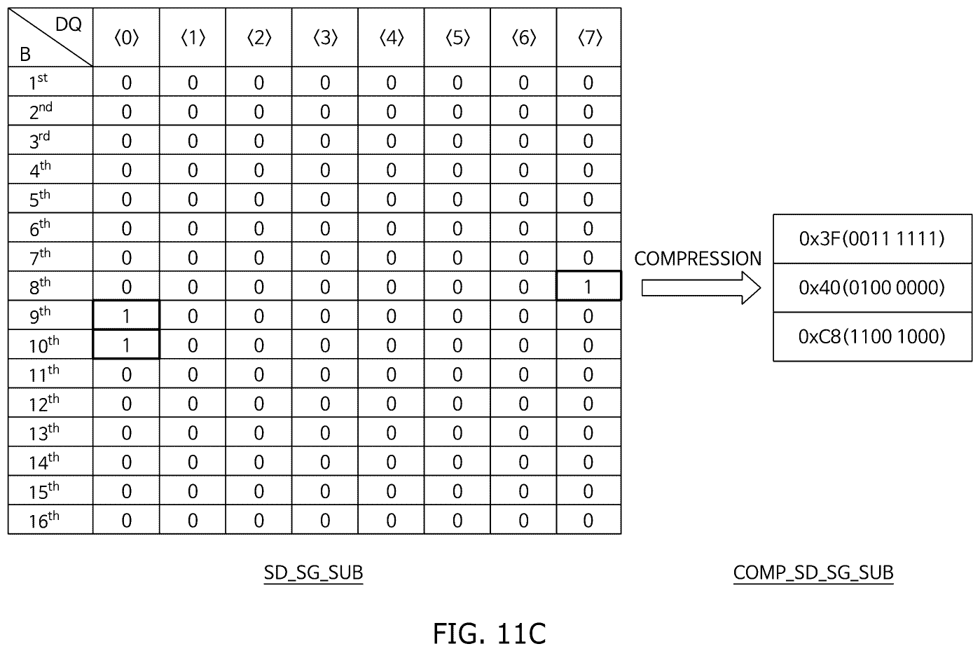

FIGS. 11A to 11C are diagrams for illustrating a method of compressing an SD data sub-segment.

Referring to FIG. 11A, only the first bit of the SD data sub-segment SD_SG_SUB is “1”, and that “1” is the last “1” of the SD data sub-segment SD_SG_SUB. Accordingly, referring to FIG. 9A, the MSB bit of the eight encoded bits may be “1”, and referring to FIG. 10, the remaining bits of the eight encoded bits may all be “0”. Accordingly, “1” of the SD data sub-segment SD_SG_SUB may be encoded as 0x80, that is, 1000 0000. In FIG. 11A, the 128-bit SD data sub-segment SD_SG_SUB may be compressed into an 8-bit compressed data sub-segment COMP_SD_SG_SUB.

Referring to FIG. 11B, since the first bit of the SD data sub-segment SD_SG_SUB is “1” and the last bit is “1”, according to FIGS. 9A and 10, the first “1” may be encoded as 0x00, that is, 0000 0000, and the last “1” may be encoded as 0xFF, that is, 1111 1111. In FIG. 11B, the 128-bit SD data sub-segment SD_SG_SUB may be compressed into a 16-bit compressed data sub-segment COMP_SD_SG_SUB.

Referring to FIG. 11C, the first “1” of the SD data sub-segment SD_SG_SUB may be encoded as 0x3F (e.g., 0011 1111), the second “1” may be encoded as 0x40 (e.g., 0100 0000), and the last “1” may be encoded as 0xC8 (e.g., 1100 1000). In FIG. 11C, the 128-bit SD data sub-segment SD_SG_SUB may be compressed into a 24-bit compressed data sub-segment COMP_SD_SG_SUB.

In an example case in which the compression ratio of the SD data sub-segment SD_SG_SUB to the compressed data sub-segment COMP_SD_SG_SUB is the same for all SD data sub-segments SD_SG_SUB, that is, in an example case in which the compression ratio has a fixed value of 25% and the compressed data sub-segment COMP_SD_SG_SUB has a fixed size including position information of four 1s, the following problems may occur.

For example, in a case in which five or more 1s (hereinafter referred to as an “error bit”) are included in the SD data sub-segment SD_SG_SUB, exceeding the maximum number of positions of error bits that can be included in the compressed data sub-segment COMP_SD_SG_SUB, the information indicating the position of some error bits may be lost in the compressed data sub-segment SD_SG_SUB process.

On the other hand, in a case in which less than four error bits are included in the SD data sub-segment SD_SG_SUB, a portion of the compressed data sub-segment COMP_SD_SG_SUB may include a dummy bit pattern (e.g., “0xFF”) so that the compressed data sub-segment COMP_SD_SG_SUB has a fixed size.

These problems may occur not only in an example case in which the SD data sub-segment SD_SG_SUB is compressed into the compressed data sub-segment COMP_SD_SG_SUB, but also in an example case in which the SD data segment SD_SG of FIG. 9B is compressed into the compressed data segment COMP_SD_SG. Therefore, it is necessary to solve the problems described above by adjusting the compression ratio of the SD data segments or the SD data sub-segments of the SD data where relatively fewer error bits are expected to occur, and adjusting the compression ratio of the SD data segments or the SD data sub-segments where relatively more error bits are expected to occur. Various embodiments for determining the compression ratio to solve the problems described above will be described below with reference to FIGS. 12 to 19.

FIG. 12 is a flowchart for illustrating an operating method of the memory device. The operating method illustrated in FIG. 12 is described below with reference to FIG. 7.

According to an embodiment, in S1210, the page buffer circuit 103 may read the HD data HDD from the memory cell array 102. For example, by using a hard read voltage, the page buffer circuit 103 may obtain the HD data HDD from the memory cell array 102 including a plurality of memory units.

According to an embodiment, in S1220, the read HD data HDD may be output to the memory controller through the memory interface circuit 106.

According to an embodiment, in S1230, the page buffer circuit 103 may read the SD data SDD including a plurality of SD data segments from the memory cell array 102. For example, the SD data SDD may be read in units of a plurality of SD data segments. The SD data SDD may be read using a soft read voltage. The SD data SDD including a plurality of SD data segments may be obtained by reading each of a plurality of SD data segments from each of a plurality of memory units in the memory cell array 102.

In an example case in which a uncorrectable error correction code (UECC) event (UECC error) occurs for the output HD data HDD, the SD data SDD may be read. For example, in an example case in which an error correction operation using an error correction circuit (e.g., 210 in FIG. 1) cannot be performed due to the UECC event occurring in the HD data HDD after receiving the HD data HDD, the memory controller (e.g., 200 in FIG. 1) may transmit a command or request to the non-volatile memory device 10 to read the SD data SDD to perform an error correction operation on the HD data. Based on receiving the command or request instructing to read the SD data SDD from the memory controller, the non-volatile memory device 10 may read the SD data. For example, in response to receiving the command or request instructing to read the SD data SDD from the memory controller, the non-volatile memory device 10 may read the SD data.

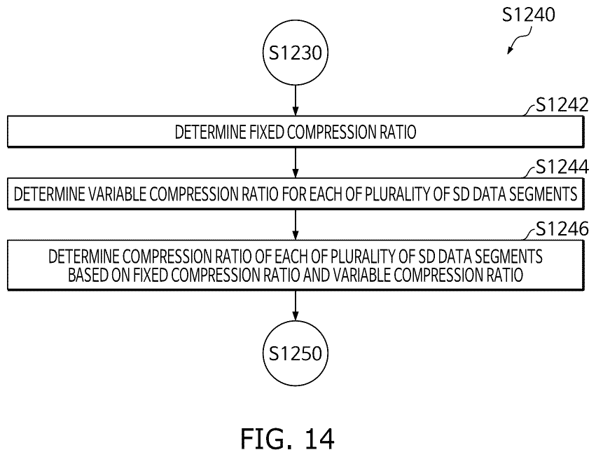

According to an embodiment, in S1240, the compression ratio of each of a plurality of SD data segments included in the SD data SDD may be determined. The compression ratio of each of the plurality of SD data segments may be determined by the detailed components such as the compression circuit 107 in the non-volatile memory device 10 that are already illustrated, or may be determined in a separate circuit or module implemented in hardware, software, and/or firmware in the non-volatile memory device 10, or the memory controller 200. Details of the process of determining the compression ratio of each of the plurality of SD data segments will be described in detail below with reference to FIG. 14.

The compression ratio may refer to a ratio (%) obtained by dividing the size of the compressed data by the size of the original data. For example, if the original data is 128 bits and the compressed data is 32 bits, the compression ratio may be 25%. The compression ratio determined to be low may indicate that the size of compressed data is relatively low compared to the size of the original data. Conversely, the compression ratio determined to be high may mean that the size of compressed data is relatively high compared to the size of the original data.

According to an embodiment, in S1250, the compression circuit 107 may compress a plurality of SD data segments based on the compression ratio determined at S1240 to generate the compressed data COMP_SD including a plurality of compressed data segments. For example, each of the plurality of SD data segments may correspond to each of the plurality of compressed data segments.

According to an embodiment, in S1250, the non-volatile memory device 10 may output the compressed data COMP_SD generated at S1250 through the memory interface circuit 106, at S1260.

The operating method of the memory device described above is not limited to the above, and one or more operations in the process illustrated and described with reference to FIG. 12 may be omitted, the order of each of the operations may be changed, one or more operations may be temporally overlapped, or one or more operations may be repeated multiple times.

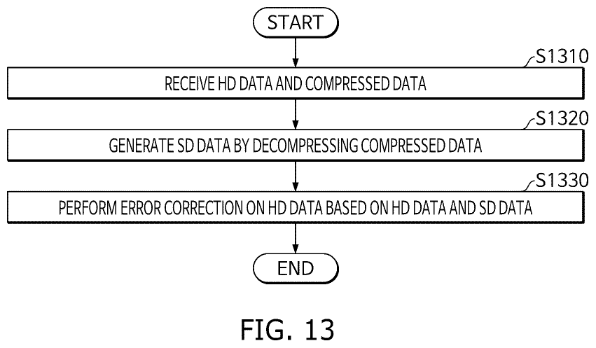

FIG. 13 is a flowchart for illustrating an operating method of the memory controller. The operating method illustrated in FIG. 13 is described below with reference to FIGS. 1 and 7 together.

According to an embodiment, in S1310, the memory controller 200 may receive HD data HDD and compressed data COMP_SD from the non-volatile memory device 10. For example, the HD data HDD may be the data generated at S1210 of FIG. 12, and the compressed data COMP_SD may be the data generated at S1250 of FIG. 12 and output at S1260.

According to an embodiment, in S1320, the memory controller 200 may decompress the received compressed data to generate SD data SDD. For example, the decompression circuit 220 may decompress the received compressed data to generate SD data SDD.

According to an embodiment, in S1320, the memory controller 200 (may perform error correction on the HD data HDD based on the HD data HDD and the SD data SDD. For example, the error correction circuit 210 may perform error correction on the HD data HDD based on the HD data HDD and the SD data SDD.

FIG. 14 is a flowchart for illustrating an operation S1240 of FIG. 12 in detail.

According to an embodiment, in S1242, a fixed compression ratio may be determined. For example, in order to determine the compression ratio of each of the plurality of SD data segments, the fixed compression ratio may be determined. The fixed compression ratio may be a compression ratio commonly applied to the plurality of SD data segments.

According to an embodiment, in S1244, a variable compression ratio may be determined. For example, in order to determine the compression ratio of each of the plurality of SD data segments, a variable compression ratio for each of the plurality of SD data segments may be determined. The variable compression ratio may be determined differently or identically to each other for each of the plurality of SD data segments.

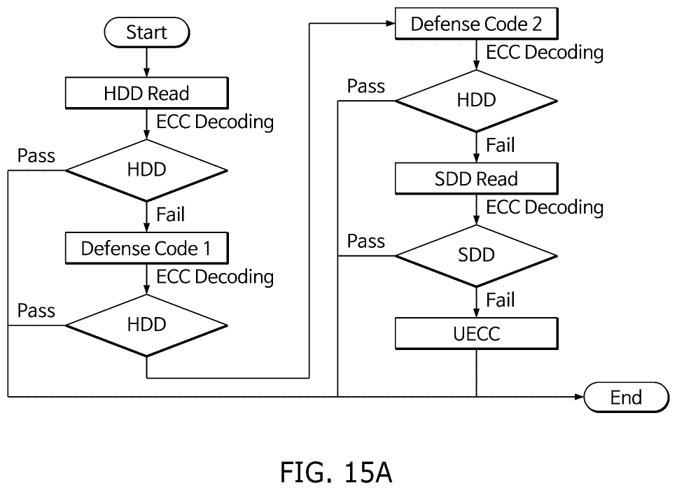

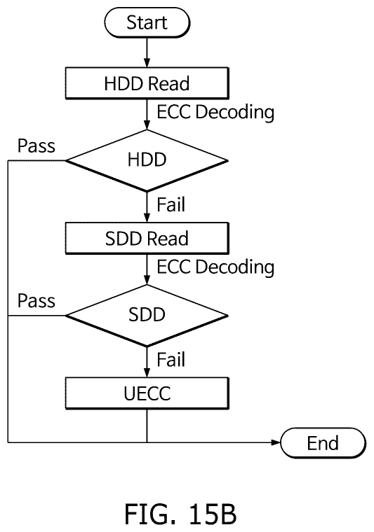

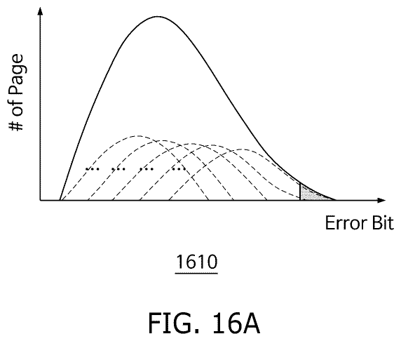

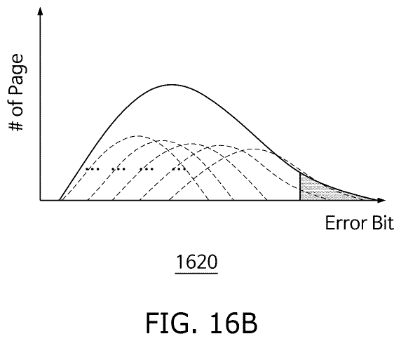

The fixed compression ratio and the variable compression ratio may be determined based on information associated with an error bit to be corrected using the SD data. Details of the process of determining the fixed compression ratio and examples thereof will be described in detail below with reference to FIGS. 15A to 16. Details of the process of determining the variable compression ratio and examples thereof will be described in detail below with reference to FIGS. 17A and 17B.

According to an embodiment, in S1244, a compression ratio of each of a plurality of SD data segments may be determined based on the determined fixed compression ratio and variable compression ratio. For example, the compression ratio of each of the plurality of SD data segments may be a sum of the fixed compression ratio and the variable compression ratio determined for the corresponding SD data segment.

In FIG. 14, the order of performing the operations S1242 and S1244 is not limited to those illustrated, and the order may be changed or the operations may be performed in parallel.

FIGS. 15A and 15B are diagrams illustrating a defense code flow of the memory system to describe an operation S1242 of FIG. 14.

Referring to FIG. 15A, in an example case in which a failure occurs after the HD data HDD read and the ECC decoding, the HD data HDD read and the ECC decoding may be performed again at a new read level using another defense code (Defense code 1). For example, the dense code may include, but is not limited to, Pre-Defined Table (PDT), Least Read Estimation (LRE), etc.. The process may be repeated using yet another defense code (Defense code 2) whenever a failure occurs after performing the read and the ECC decoding, and the defense code may be executed for any number of times as long as the failure continues to occur after performing the HD data HDD read and the ECC decoding.

In an example case in which a failure occurs after performing the read and the ECC decoding a reference number of times, the SD data SDD is read and compressed, and the error correction process of the HD data HDD described above with reference to FIG. 13, etc. may be executed. In an example case in which a UECC error occurs even after the SD data SDD read, correction such as changing the soft decision offset may be attempted.

In an example case in which the defense code is executed, at least a portion of a plurality of error bits of the HD data HDD may be corrected. In another example case in which the defense code is executed, the error bit of the HD data HDD may not be corrected (Fail).

In an example case in which at least a portion of the plurality of error bits of the HD data HDD is corrected by the execution of the defense code, the number of error bits of the HD data HDD to be corrected through the SD data SDD read may be reduced. On the other hand, if the error bit of the HD data HDD is not corrected even in an example case in which the defense code is executed, the number of error bits of the HD data HDD to be corrected through the SD data SDD read may be maintained as is.

Referring to FIG. 15B, unlike FIG. 15A, in an example case in which a failure occurs after performing the HD data read and ECC data, the SD data SDD may be read immediately without using another defense code.

In FIGS. 15A and 15B, a process of determining ECC level (“Determine ECC level”) may be executed before the error correction process using the SD data SDD is executed. For example, in the process of determining ECC level, the number of error bits corrected by the defense code among a plurality of error bits of HD data HDD and/or the number of error bits to be corrected using SD data SDD may be calculated. In one example, the number of error bits to be corrected using the SD data SDD may be calculated based on the number of error bits of the initial HD data HDD and the number of error bits corrected by a defense code among a plurality of error bits of the HD data HDD.

As the number of error bits to be corrected by using the SD data SDD decreases (or, is expected to decrease), a lower fixed compression ratio of the SD data SDD may be determined, and thus the size of the compressed data COMP_SD may decrease. For example, a lower fixed compression ratio may be determined as the number of error bits corrected by one or more executed defense codes increases. On the other hand, as the number of error bits to be corrected using the SD data SDD increases (or, is expected to increase), a higher fixed compression ratio may be determined, and thus loss of information can be prevented during compression of the SD data SDD. For example, a higher fixed compression ratio may be determined as the number of error bits corrected by the one or more executed defense codes decreases.

In an example case in which one or more defense codes are executed on the data read from the memory cell array before obtaining the SD data SDD at S1242 of FIG. 14, the determined fixed compression ratio may be lower than the fixed compression ratio in an example case in which the defense code has not been executed before obtaining the SD data SDD. In addition, a lower fixed compression ratio may be determined as the number of executed defense codes increases.

FIGS. 16A and 16B are diagrams illustrating an error profile of the memory device to explain the operation S1242 of FIG. 14. For example, FIG. 16A illustrates a graph 1610 and FIG. 16B illustrates a graph 1620. In each of graphs 1610 and 1620, the dotted line represents the number (y-value) of pages having an occurrence of error bits occur by a specific number (x-value) during the data read in each of the plurality of blocks in the memory cell array, and the solid line represents the number of pages in which error bits occur by a specific number during the data read in the memory cell array including the plurality of blocks.

At S1242 of FIG. 14, a lower fixed compression ratio may be determined as the number of memory units, among the plurality of memory units, in which error bits occur at or above a threshold during the data read decreases.

In an example case in which the memory unit is a page, the number of memory units (area of the shaded portion) in which error bits occur at or above the threshold when the memory cell array has the same error bit characteristics as the first graph 1610 may be less than the number of memory units (area of the shaded portion) in which error bits occur at or above the threshold when the memory cell array has the same error bit characteristic as the second graph 1620. In this case, a higher fixed compression ratio may be determined when the memory cell array has the same error bit characteristic as the second graph 1620 than when the memory cell array has the same error bit characteristic as the first graph 1610.

For example, by determining a lower fixed compression ratio as the number of error bits to be corrected using the SD data SDD decreases (or, is expected to decrease), it is possible to reduce the size of the compressed data COMP_SD. On the other hand, by determining a higher fixed compression ratio as the number of error bits to be corrected using the SD data increases (or, is expected to increase), it is possible to prevent the loss of information during compression of the SD data SDD.

FIG. 17A is a flowchart for illustrating the operation S1244 of FIG. 14 in detail, and FIG. 17B is a diagram illustrating an example where a variable compression ratio is determined according to the number of error bits per memory unit.

The variable compression ratio may be determined based on the number of error bits generated on the HD data for each of a plurality of memory units. The HD data may be the data obtained from the memory cell array including the plurality of memory units using the hard read voltage at S1210 of FIG. 12.

Referring to FIG. 17A, according to an embodiment, in S1244_1, a memory device may obtain a number of error bits generated in the HD data of a first memory unit. For example, the memory device (e.g., the memory device 10 in FIG. 2A) may use a bit counter (e.g., the bit counter 108 in FIG. 2A) to calculate (or count) the number of error bits generated in the HD data of a first memory unit, which is one of the plurality of memory units.

According to an embodiment, in S1244_2, the memory device may obtain a number of error bits generated in the HD data of a second memory unit. For example,, the memory device may calculate (or count) the number of error bits generated in the HD data of a second memory unit, which is one of the plurality of memory units, using a bit counter.

According to an embodiment, in S1244_3, the memory device may determine a first variable compression ratio to be higher than a second variable compression ratio based on the number of error bits generated in HD data for the first memory being greater than the number of error bits generated in HD data for the second memory unit. For example, in a case in which the number of error bits generated in HD data for the first memory unit is greater than the number of error bits generated in HD data for the second memory unit, the first variable compression ratio applied to the first SD data segment obtained from the first memory unit may be determined to be higher than the second variable compression ratio applied to the second SD data segment obtained from the second memory unit.

For example, as the number of error bits generated in positions within the HD data corresponding to a specific memory unit increases, a higher variable compression ratio may be given to the SD data segment obtained from the specific memory unit, thereby preventing a problem of information loss during SD data compression. On the other hand, as the number of error bits generated in positions within the HD data corresponding to a specific memory unit decreases, a lower variable compression ratio may be given, thereby preventing a problem in which the capacity of the compressed data is unnecessarily increased due to insertion of a dummy bit pattern, etc. during SD data compression.

Referring to FIG. 17B, a plurality of variable compression ratios may be determined according to the number of error bits generated in the HD data for a plurality of memory units. For example, the plurality of memory units may include, but is not limited to, Unit 1, Unit 2, Unit 3 and Unit 4.

The variable compression ratio may be determined to be a predetermined offset value or a multiple thereof, for a specific range of error bit counts. For example, a variable compression ratio may be determined as a multiple of 5% offset according to the number of error bits in Units 1 to 4, as in the example of FIG. 17B. According to another embodiment, the variable compression ratio may increase in proportion to the number of error bits.

The plurality of variable compression ratios may include a first part that is positive and a second part that is negative. Additionally, a sum of the plurality of variable compression ratios may be 0. In this case, compressed data having the same size as when the SD data is compressed at a fixed compression ratio without applying a variable compression ratio may be generated.

In an example case in which the variance of the number of error bits occurring in each of the plurality of memory units is equal to or greater than a threshold, the plurality of variable compression ratios may be determined to be 0. In another example case in which the difference in the number of error bits occurring in two memory units of the plurality of memory units is less than a specific threshold, the plurality of variable compression ratios may be determined to be 0.

The example of the variable compression ratio in FIG. 17B is based on the assumption that the fixed compression ratio is 40%, and the final compression ratio of the SD data segment generated from each memory unit may be determined to be 30%, 35%, 45%, and 50%, respectively, as the sum of the fixed compression ratio and the variable compression ratio.

Although four memory units are illustrated in FIG. 17B as an example of the plurality of memory units for convenience of description, the memory cell array may include a plurality of memory units of any number.

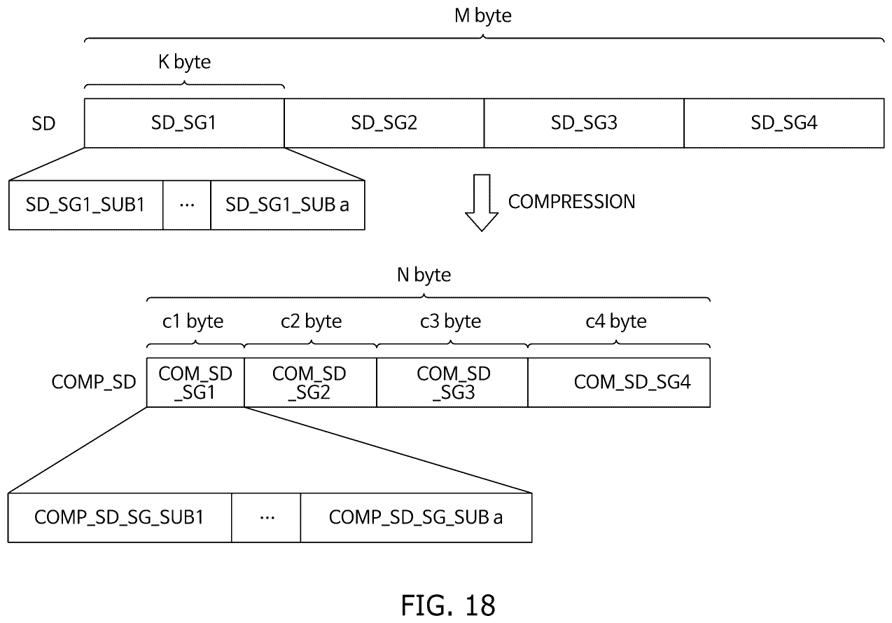

FIG. 18 illustrates an example of compressed data COMP_SD. FIG. 18 illustrates that both the number of a plurality of SD data segments SD_SG1 to SD_SG4 and the number of a plurality of compressed data segments COM_SD_SG1 to COM_SD_SG4 are four, respectively, but the disclosure is not limited thereto.

The plurality of SD data segments SD_SG1 to SD_SG4 may be obtained from the plurality of memory units of the memory cell array. Each of the plurality of SD data segments SD_SG1 to SD_SG4 may be compressed at a different compression ratio based on the fixed compression ratio and the plurality of variable compression ratios determined for the plurality of SD data segments SD_SG1 to SD_SG4. As a result, the sizes of the plurality of compressed data segments COM_SD_SG1 to COM_SD_SG4 may be different from each other. For example, a size c4 of the fourth compressed data segment COM_SD_SG4 may be the largest and may include information on the most error bits. On the other hand, a size c1 of the first compressed data segment COM_SD_SG1 may be the smallest and may include information on the fewest error bit.

Each of the plurality of compressed data segments COM_SD_SG1 to COM_SD_SG4 may include a bit pattern indicating the start, end, or size information for itself, such that each of the plurality of compressed data segments COM_SD_SG1 to COM_SD_SG4 may be distinguished.

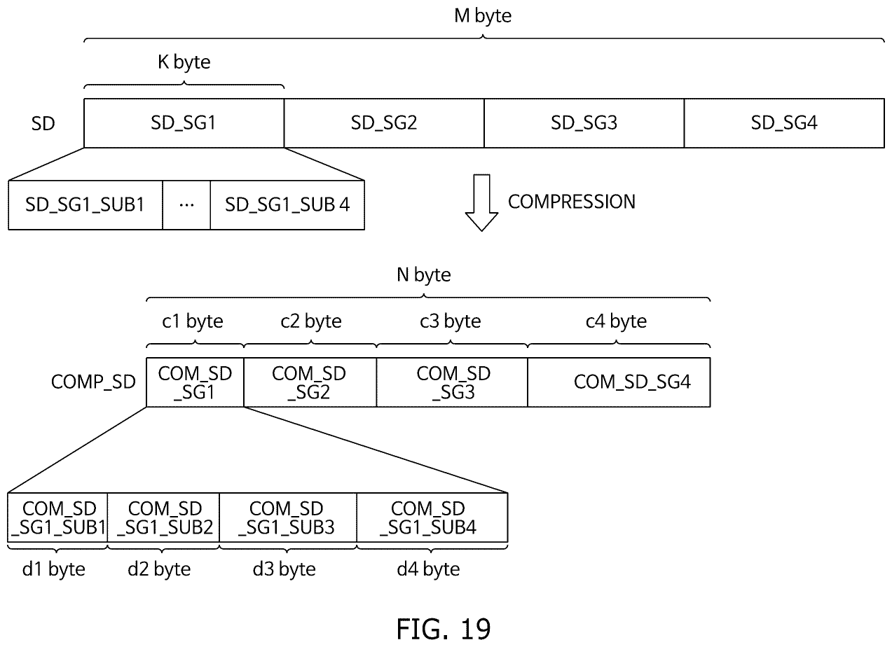

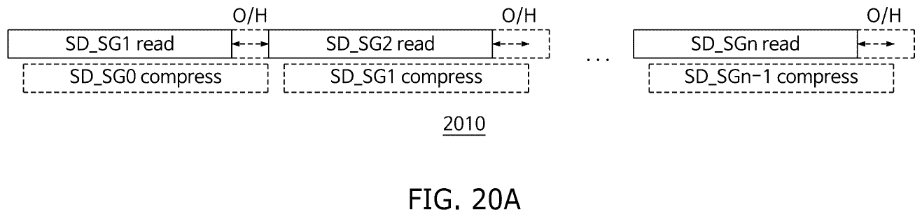

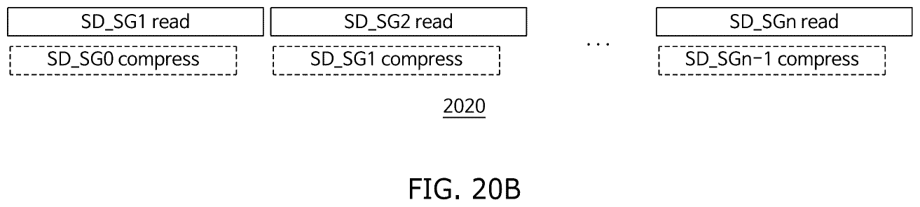

FIG. 19 is a diagram illustrating an example of compressed data sub-segments COM_SD_SG1_SUB1 to COM_SD_SG1_SUB4.

Each of the plurality of memory units may include a plurality of memory sub-units, and each of the plurality of SD data segments SD_SG1 to SD_SG4 may include a plurality of SD data sub-segments SD_SG1_SUB1 to SD_SG1_SUB4 obtained from the plurality of memory sub-units. One or more embodiments will be described below based on one SD data segment SD_SG1 and the corresponding compressed data segment COM_SD_SG1, but it should be understood that the disclosure is not limited thereto, and as such, similar features and/or aspects of the disclosure may also be applicable to other SD data segments SD_SG2 to SD_SG4 and other compressed data segments COM_SD_SG2 to COM_SD_SG4.

The SD data segment SD_SG1 may be compressed based on a sub-fixed compression ratio and a plurality of sub-variable compression ratios applied to the plurality of SD data sub-segments SD_SG1_SUB1 to SD_SG1_SUB4.

The sub-fixed compression ratio of the plurality of SD data sub-segments SD_SG1_SUB1 to SD_SG1_SUB4 may be determined as the sum of the fixed compression ratio and the variable compression ratio of the SD data segment SD_SG1. Therefore, different sub-fixed compression ratios may be applied to the different SD data segments SD_SG2 to SD_SG4.

The plurality of sub-variable compression ratios of the plurality of SD data sub-segments SD_SG1_SUB1 to SD_SG1_SUB4 may include a first sub-variable compression ratio applied to a first SD data sub-segment obtained from a first memory sub-unit among the plurality of memory sub-units, and a second sub-variable compression ratio applied to a second SD data sub-segment obtained from a second memory sub-unit among the plurality of memory sub-units. In an example case in which the number of error bits generated in the HD data for the first memory sub-unit is greater than the number of error bits generated in the HD data for the second memory sub-unit, the first sub-variable compression ratio may be determined to be higher than the second sub-variable compression ratio.

Each of the plurality of SD data sub-segments SD_SG1_SUB1 to SD_SG1_SUB4 may be compressed at a different compression ratio based on the sub-fixed compression ratio and the plurality of sub-variable compression ratios determined for the plurality of SD data sub-segments SD_SG1_SUB1 to SD_SG1_SUB4. As a result, the sizes of the plurality of compressed data segments COM_SD_SG1_SUB1 to COM_SD_SG1_SUB4 may be different from each other. For example, a size d4 of the fourth compressed data sub-segment COM_SD_SG1_SUB4 may be the largest and may include information on the most error bits. On the other hand, a size d1 of the first compressed data sub-segment COM_SD_SG1_SUB1 may be the smallest and may include information on the smallest error bit.

Each of the plurality of memory units may be a plurality of pages, and each of the plurality of memory sub-units may be one page. In another aspect, each of the plurality of memory units may be one page, and each of the plurality of memory sub-units may be a portion of one page.

FIGS. 20A and 20B are diagrams illustrating an example in which an overhead (O/H) is reduced in the SD data SDD read operation.

FIG. 20A illustrates a first example 2010 in which the same compression ratio is applied to the plurality of SD data segments SD_SG0 to SD_SGn, and in this case the compression operation of the data segment read in the previous step is not completed, and thus an overhead occurs during the read operation of the data segment in the next step.

FIG. 20B illustrates a second example 2020 in which a lower compression ratio is determined as the number of error bits to be corrected using the plurality of SD data segments SD_SG0 to SD_SGn decrease (or, is expected to decrease) such that the size of the compressed data as well as the time required for the compression operation for some SD data segments is reduced, resulting in reduced or no overhead according to various aspects.

As described above, example aspects are disclosed in the drawings and the description. Although aspects have been described using specific terms in the present description, these terms are used only for the purpose of explaining the technical idea of the disclosure and not to limit the meaning or the scope of the disclosure described in the claims. Therefore, those with ordinary knowledge in the art will understand that various modifications and other equivalent aspects are possible. Therefore, the true technical protection scope of the disclosure should be determined by the technical idea of the appended claims.

What is claimed is:

1. A memory device, comprising:
a memory cell array comprising a plurality of memory units;
a page buffer circuit configured to acquire, using a soft read voltage, soft decision (SD) data comprising a plurality of SD data segments from the plurality of memory units; and
a compression circuit configured to compress the SD data into compressed data comprising a plurality of compressed data segments corresponding to the plurality of SD data segments, wherein the plurality of compressed data segments of the compressed data are generated by compressing the plurality of SD data segments according to a fixed compression ratio and a plurality of variable compression ratios,
wherein the fixed compression ratio is determined based on information associated with an error bit to be corrected using the SD data, and
wherein the plurality of variable compression ratios is respectively applied to the plurality of SD data segments.

2. The memory device according to claim 1, wherein, based on one or more defense codes being executed on data read from the memory cell array before acquiring the SD data, the fixed compression ratio has a first fixed compression ratio, and based on no defense code being executed before acquiring the SD data, the fixed compression ratio has a second fixed compression ratio, and
wherein the first fixed compression ratio is lower than the second fixed compression ratio.

3. The memory device according to claim 2, wherein the fixed compression ratio decreases as a number of error bits corrected by the one or more defense codes being executed increases.

4. The memory device according to claim 1, wherein the fixed compression ratio decreases as a number of memory units in which a number of error bits occurred during data read is equal to or greater than a threshold decreases, among the plurality of memory units.

5. The memory device according to claim 1, wherein
the page buffer circuit is further configured to acquire, using a hard read voltage, hard decision (HD) data from the memory cell array comprising the plurality of memory units, and
wherein the plurality of variable compression ratios are determined based on a number of error bits generated on the HD data for each of the plurality of memory units.

6. The memory device according to claim 5, wherein
the plurality of variable compression ratios comprise:
a first variable compression ratio applied to a first SD data segment acquired from a first memory unit among the plurality of memory units; and
a second variable compression ratio applied to a second SD data segment acquired from a second memory unit among the plurality of memory units, and
wherein, based on a number of error bits generated for the first memory unit being greater than a number of error bits generated for the second memory unit, the first variable compression ratio is determined to be higher than the second variable compression ratio.

7. The memory device according to claim 5, wherein
the memory device further comprises a bit counter configured to count a number of error bits generated on the HD data for each of the plurality of memory units, and
wherein the plurality of variable compression ratios are determined based on the number of error bits counted by the bit counter.

8. The memory device according to claim 5, wherein, based on a variance of the number of error bits generated for each of the plurality of memory units being equal to or greater than a threshold, the plurality of variable compression ratios are determined to be 0.

9. The memory device according to claim 1, wherein the plurality of variable compression ratios comprise a first part that is positive and a second part that is negative.

10. The memory device according to claim 9, wherein a sum of the plurality of variable compression ratios is 0.

11. The memory device according to claim 1, wherein each of the plurality of memory units is a page.

12. The memory device according to claim 1, wherein each of the plurality of compressed data segments comprises a bit pattern indicating start information, end information, or size information of each of the plurality of compressed data segments.

13. The memory device according to claim 1, wherein the compression circuit is further configured to generate the compressed data by encoding a position of a bit having a first value among a plurality of bits of the SD data.

14. The memory device according to claim 13, wherein
a bit in the SD data representing the first value corresponds to an area having a relatively low read reliability in threshold voltage distributions of a plurality of memory cells included in the memory cell array, and
a bit in the SD data representing a second value different from the first value corresponds to an area having a relatively high read reliability in the threshold voltage distributions.

15. The memory device according to claim 1, wherein
the page buffer circuit is further configured to:
acquire HD data, using a hard read voltage, from the memory cell array comprising the plurality of memory units; and
acquire the SD data based on an uncorrectable error correction code (UECC) event occurred for the HD data.

16. The memory device according to claim 1, wherein
each of the plurality of memory units comprises a plurality of memory sub-units,
each of the plurality of SD data segments comprises a plurality of SD data sub-segments acquired from the plurality of memory sub-units, and
the compression circuit is further configured to compress a first SD data segment among the plurality of SD data segments based on a sub-fixed compression ratio and a plurality of sub-variable compression ratios applied to the plurality of SD data sub-segments included in the first SD data segment.

17. The memory device according to claim 16, wherein
the page buffer circuit is further configured to acquire, using a hard read voltage, HD data from the memory cell array comprising the plurality of memory sub-units,
the sub-fixed compression ratio is determined based on a sum of the fixed compression ratio and the variable compression ratio of the first SD data segment,
the plurality of sub-variable compression ratios comprise:
a first sub-variable compression ratio applied to a first SD data sub-segment acquired from a first memory sub-unit among the plurality of memory sub-units; and
a second sub-variable compression ratio applied to a second SD data sub-segment acquired from a second memory sub-unit among the plurality of memory sub-units, and
based on the number of error bits generated on the HD data for the first memory sub-unit being greater than the number of error bits generated on the HD data for the second memory sub-unit, the first sub-variable compression ratio is determined to be higher than the second sub-variable compression ratio.

18. The memory device according to claim 16, wherein
each of the plurality of memory units is a plurality of pages, and
each of the plurality of memory sub-units is one page.

19. An operating method of a memory device, comprising:
acquiring soft decision (SD) data comprising a plurality of SD data segments from a plurality of memory units in a memory cell array using a soft read voltage;
determining a fixed compression ratio and a plurality of variable compression ratios applied to each of the plurality of SD data segments based on information associated with an error bit to be corrected using the SD data; and
generating compressed data comprising a plurality of compressed data segments corresponding to the plurality of SD data segments based on the fixed compression ratio and the plurality of variable compression ratios.

20. A memory system, comprising:
a memory device configured to:
acquire hard decision (DD) data from a memory cell array comprising a plurality of memory units using a hard read voltage,
acquire soft decision (SD) data comprising a plurality of SD data segments from the plurality of memory units using a soft read voltage,
determine a fixed compression ratio and a plurality of variable compression ratios applied to each of the plurality of SD data segments based on information associated with an error bit to be corrected using the SD data, and
generate compressed data comprising a plurality of compressed data segments corresponding to the plurality of SD data segments based on the fixed compression ratio and the plurality of variable compression ratios; and
a memory controller configured to:
receive the HD data and the compressed data,
decompress the compressed data to acquire the SD data, and
correct an error in the HD data based on the HD data and the SD data.
